(19) United States
(12) Patent Application Publication
(10) Pub. No.: US 2024/0364600 A1
(43) Pub. Date: Oct. 31, 2024

(54) TOPOLOGY HIDING IN 5GC WITH ROAMING

(71) Applicant: Telefonaktiebolaget LM Ericsson (publ), Stockholm (SE)

(72) Inventors: Maria Cruz BARTOLOME RODRIGO, Madrid (ES); Mary Amarisa ROBISON, Aachen (DE)

(21) Appl. No.: 18/688,604

(22) PCT Filed: Sep. 1, 2022
(86) PCT No.: PCT/IB2022/058198

§ 371 Date: Mar. 1, 2024

(30) Foreign Application Priority Data
Sep. 2, 2021 (EP) 21382792.6

(51) Int. Cl. H04L 41/28; H04L 41/12; H04W 8/02; H04W 12/03; H04W 84/04

(52) U.S. Cl. CPC H04L 41/28; H04L 41/12; H04W 8/02; H04W 12/03; H04W 84/042

(57) ABSTRACT

A method implemented by a network node in a communication infrastructure, that includes a plurality of Public Land Mobile Networks (PLMNs), the method includes receiving, by a Network Function Repository Function (pNRF) node of a producer PLMN (pPLMN), a network function (NF) discovery request for a particular service from a network node of a consumer PLMN (cPLMN). The method also includes determining, by the pNRF node, if topology hiding is required for a NF instance that provides the particular service. The method further includes transmitting, by the pNRF node, a discovery response comprising one or more external NF instances, wherein each external NF instance comprises one or more internal NF instances in a Set of NF instances of the pPLMN that require topology hiding from the cPLMN.

### TECHNICAL FIELD

The present disclosure relates generally to communications, and more particularly to communication methods and related devices and nodes supporting wireless communications.

### BACKGROUND

In a 5th Generation Core Network (5GC), some network functions (NFs) in a consumer Public Land Mobile Network (cPLMN) or visited PLMN (vPLMN) requested by a roaming user access services in a producer PLMN (pPLMN) or home PLMN (hPLMN). For example, an Access and Mobility Management Function (AMF) requires access to Unified Data Management (UDM) services. There currently exist certain challenge(s) when a network function (NFc) in a cPLMN requests services from a pPLMN. Information in a pPLMN NFp profile is accessible/visible in the cPLMN. The information will be known by the NFc, as well as the Service Communication Proxy (SCP) that discovers the NFp profiles. Network operators have an interest to hide information of its network from other network operators. In particular, network operators have an interest to hide deployment and number of NF instances.

### SUMMARY

Certain aspects of the disclosure and their embodiments may provide solutions to these or other challenges.

Embodiments described herein provide a mechanism that allows a plurality of NF instances (even with its internal NF service instances) defined in a pPLMN to be hidden under one single external NF instance. The external NF instance will be the only NF instance visible in a cPLMN. One or multiple instances in a same Set are hidden under a single external NF instance, as long as, all the instances in the Set are functionally equivalent and share the same data, i.e., the resource is unique and accessible by all the NF instances in the Set. This is applicable to a NF (service) Set.

The solution adds some extra information at registration of an NFp instance, that includes the information of the “external” NFp. Examples of the extra information include but are not necessarily limited to at least an external NFp instance Id and an External Fully Qualified Domain Name (FQDN). In another embodiment, the information of the “external” NFp could be configured in the NF Repository Function (NRF) rather than updating the registration procedure.

At discovery from a different PLMN (via a Security Edge Protection Proxy (SEPP)), the cNRF provides as a result just the external NF instance or instances. The profile data of the external NF instance is a kind of “merging” and adaptation of the individual NF profiles as described in more detail herein. Then, from the cPLMN, only the external NF instance profile or profiles are provided.

An initial request is sent to the external NFp instance, and then the SEPP needs to get an individual NFp instance in the pPLMN. If there is indirect communication in the pPLMN, these topology hiding tasks may be performed by a Service Communication Proxy (SCP) in the incoming signaling path in the pPLMN, instead of by the SEPP.

The SEPP or SCP for each request needs to identify that the request is towards an “external” NF instance, and then the SEPP or SCP determines that topology hiding was performed. Then, the SEPP or SCP needs to determine the real NF instance profiles and send the request to any of them. In the response, the SEPP or SCP is required to perform topology hiding for any field that may include the identification of the real NF instance in the pPLMN, like at least the Location header, that identifies the created resource for the request.

Subsequent requests will be sent from the cPLMN to the external NFp including the ResourceId/URI provided in the Location header included in the response of the initial request. Then, the pSEPP or alternatively SCP stores a map between the internal selected NF instance for that external NFp, for that specific created ResourceId. This mapping information is used to identify the initially selected internal NFp instance to use the same one for the subsequent request. A subsequent request either selects any (real) NFp again, or if the same NFp instance that was selected for the initial request needs to be selected for a subsequent request, this can be accomplished by caching the mapping. This solution supports the implementations of the 3rd Generation Partnership Project (3GPP) Set where there is some session stickiness (then the same NFp instance should be selected).

Certain embodiments may provide one or more of the following technical advantage(s) in addition to others. The embodiments described herein provide topology hiding of one or multiple NF instances in an NF Set, with some logic in the pSEPP or SCP, as well as NRF, without having the need to define new operations, or to store mapping data in any node.

The embodiments described herein provide just part of the instances of a SetX in a pPLMN to a cPLMN, that will be used for roaming requests, while for requests in the same pPLMN, all of the instances in the SetX could be accessible, or alternatively, in some embodiments, instances used for roaming are not used within the pPLMN.

At least some embodiments described herein are applicable to all the NF types, as long as the Set concept is implemented according to the 3GPP standard, i.e., any NF instance in the Set provides same results.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a signal or message flow diagram in a communications infrastructure illustrating an example of network function (NF) registration and topology hiding according to some embodiments of inventive concepts.

FIGS. 2A and 2B are a flow chart of an example of a method for NF registration and topology hiding according to some embodiments of inventive concepts.

FIGS. 3A-3E is table including a NF profile according to some embodiments of inventive concepts.

FIG. 4 is a signal or message flow diagram in a communication infrastructure illustrating an example of configuration without registration and topology hiding according to some embodiments of inventive concepts.

FIGS. 5A-5B are a flow chart of an example of a method for topology hiding according to some embodiments of inventive concepts.

FIG. 6 is a signal or message flow diagram in a communication infrastructure illustrating an example of topology hiding implemented in a pSEPP node of a pPLMN according to some embodiments of inventive concepts.

FIGS. 7A-7C are a flow chart of an example of a method for topology hiding according to some embodiments of inventive concepts.

FIG. 8 is a signal or message flow diagram in a communication infrastructure illustrating an example of topology hiding implemented in a SCP node of a pPLMN according to some embodiments of inventive concepts.

FIG. 9 is a signal or message flow diagram in a communication infrastructure illustrating an example of a variant of receiving a subsequent request for a service by a pSEPP according to some embodiments of inventive concepts.

FIG. 10 is a signal or message flow diagram in a communication infrastructure illustrating an example of the variant in FIG. 9 including selecting an alternative NF instance of a Set according to some embodiments of inventive concepts.

FIGS. 11A and 11B are a signal or message flow diagram in a communication infrastructure illustrating an example of a variant of receiving a subsequent request for a service by a SCP according to some embodiments of inventive concepts.

FIG. 12 is a signal or message flow diagram in a communication infrastructure illustrating an example of the variant in FIGS. 11A and 11B including selecting an alternative NF instance of a Set according to some embodiments of inventive concepts.

FIG. 13 is a block diagram illustrating a wireless device UE according to some embodiments of inventive concepts;

FIG. 14 is a block diagram illustrating a radio access network RAN node (e.g., a base station eNB/gNB) according to some embodiments of inventive concepts;

FIG. 15 is a block diagram illustrating a core network CN node (e.g., an AMF node, an SMF node, etc.) according to some embodiments of inventive concepts;

FIG. 16 is a block diagram of a communication system in accordance with some embodiments;

FIG. 17 is a block diagram of a user equipment in accordance with some embodiments

FIG. 18 is a block diagram of a network node in accordance with some embodiments;

FIG. 19 is a block diagram of a host computer communicating with a user equipment in accordance with some embodiments;

FIG. 20 is a block diagram of a virtualization environment in accordance with some embodiments; and

FIG. 21 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

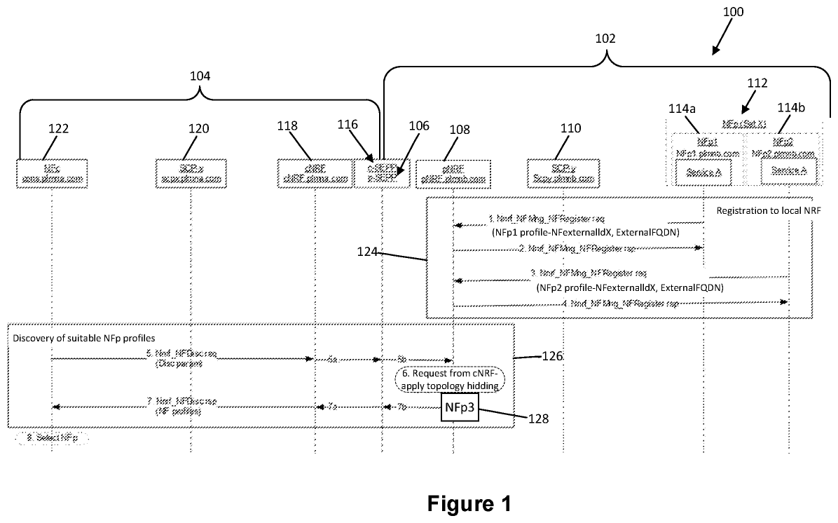

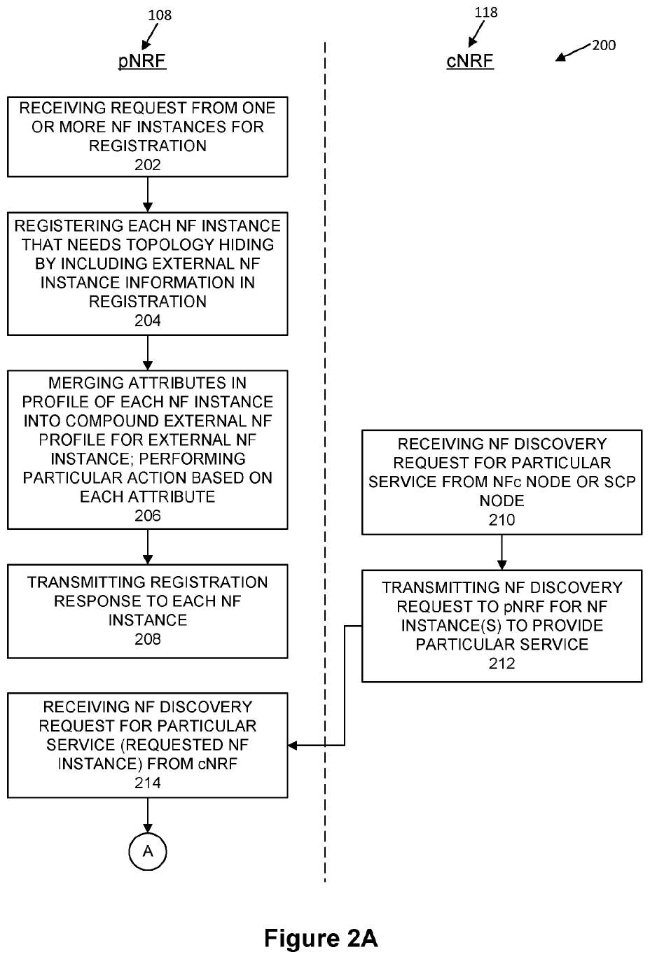

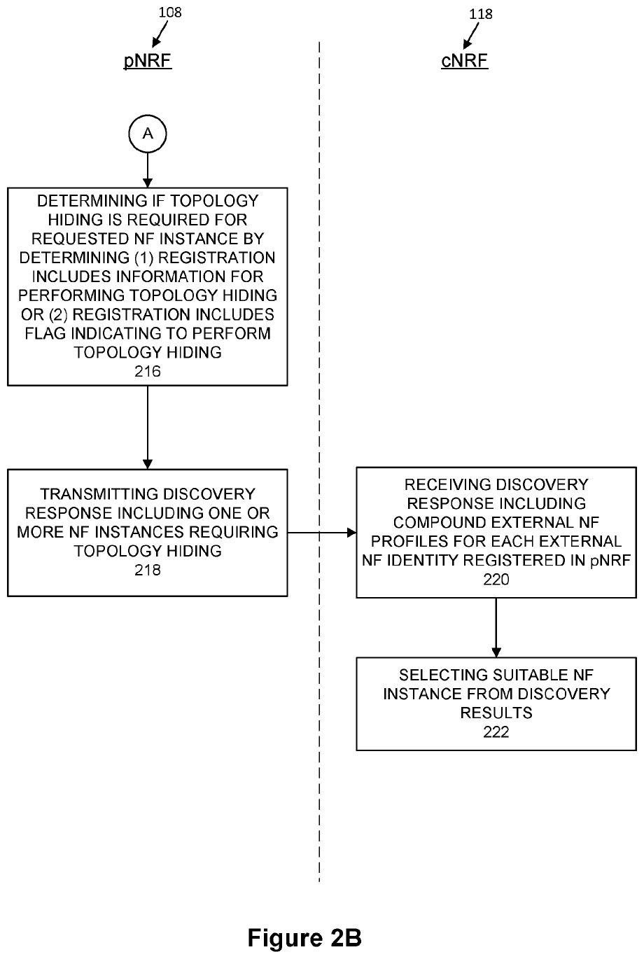

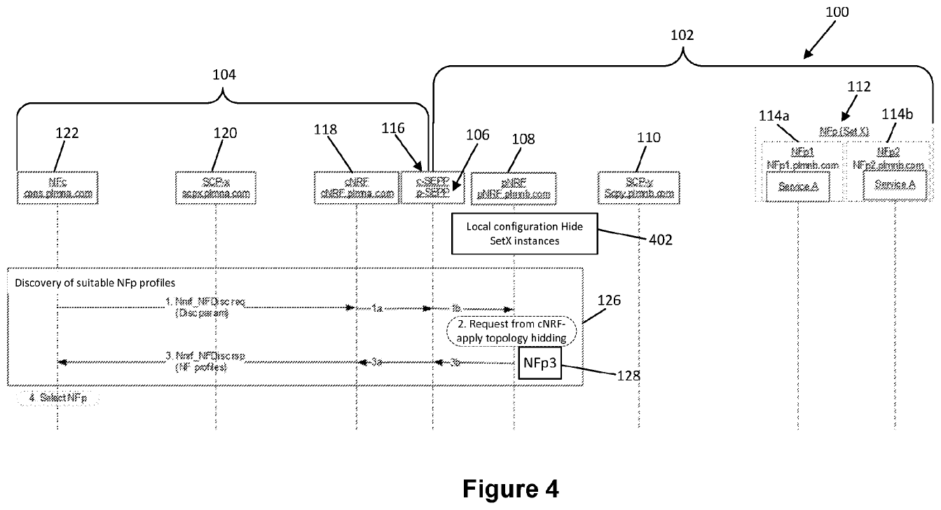

As previously indicated, embodiments described herein provide a new “External NF instance” visible from the cPLMN, that hides a number of NF instances (even with its internal NF service instances) defined in the pPLMN. Specifically, the embodiments hide all or at least some of the NF instances in a Set of NF instances. Embodiments include registration of NF instances and discovery of suitable NFp profiles with topology hiding as described in more detail with reference to FIGS. 1 and 2A-2B, and alternatively, configuration of NF instances within a NF Repository Function (pNFR) node of a pPLMN without registration. Embodiments also include discovery of suitable NFp profiles with topology hiding as described with reference to FIG. 4.

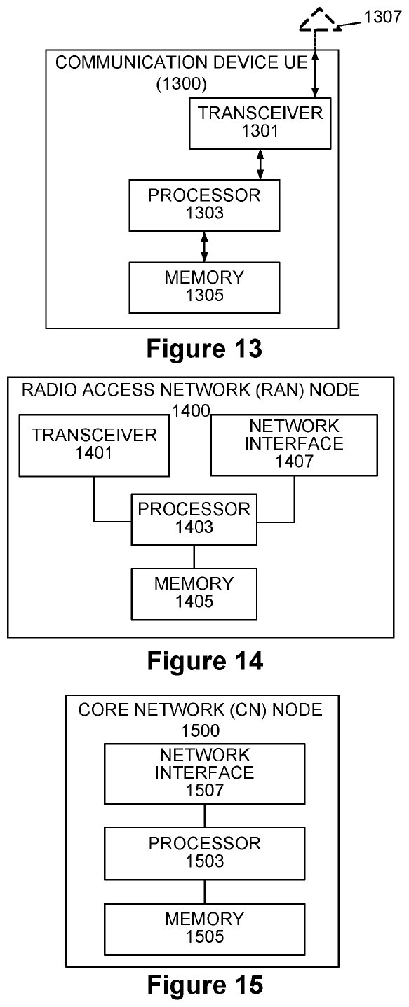

FIG. 1 is a signal or message flow diagram in a communications infrastructure 100 illustrating an example of network function (NF) registration and topology hiding according to some embodiments of inventive concepts. The communications infrastructure 100 includes a producer Public Land Mobile Network (pPLMN) 102 and a consumer Public Land Mobile Network 104 (cPLMN). The pPLMN 102 includes a Security Edge Protection Proxy (pSEPP) node 106, a Network Function Repository Function (pNRF) node 108, and a Service Communication Proxy (SCP-y) or pSCP 110, that are each configured to perform at least the functions as described herein. Examples of implementations of nodes for pSEPP node 106, pNRF 108 and SCP-y 110 are described with reference to FIGS. 13 and 14. The pSEPP node 106 may also be referred to as simply pSEPP 106. Similarly, the pNRF node 108 may be referred to as pNRF 108. Other implementations capable of performing the functions described herein for each of the nodes are also useable. In the example illustrated in FIG. 1, the pPLMN 102 also includes a Set of network functions instances (NFp (Set X)) 112. Each of the network functions instance (NFp1) 114a and (NFp2) 114b provide a particular service, e.g., Service A in the example in FIG. 1. All NF instances 114 that are functionally equivalent belong to the same Set 112. The pPLMN 102 may include a plurality of different Sets and each Set may include a plurality of NF instances that are functionally equivalent.

The cPLMN 104 also includes a cSEPP node 116, a cNRF node 118, a SCP-x node 120 and a NFc node 122. Examples of implementations of nodes for cSEPP node 116, cNRF 118 and SCP-x 120 are described with reference to FIGS. 13 and 14. Other implementations may also be used. The pSEPP 106 and cSEPP 116 are shown as a single block in the example in FIG. 1 and other Figures but are actually separate SEPPs for each PLMN. Communications between the pPLMN 102 and the cPLMN 104 pass between the respective SEPPs 106 and 116. As described herein the pSEPP 106 is configured to perform certain functions for topology hiding.

FIG. 1 illustrates an example of the steps 124 in registration of NFp instances 114 in the local pNRF 108 in the pPLMN 102 and the steps 126 in discovery of suitable NFp profiles by a network node (NFc) 122 in the cPLMN 104. Step 1: A registration request is received by the pNRF 108 from one or more NF instances 114a and 114b for registration. In the registration of each NF instance that needs to be hidden behind a unique External NF instance, new data that identifies the External NF instance is provided. In the example in FIG. 1, NF instance Id1 (NFp1) 114a and NF instance Id2 (NFp2) 114b are hidden under an external NF instance Id 3 (NFp3) 128. If there are more instances in the SetX 112, not all instances need to be defined to be accessible under the external NF instance Id3 (NFp3) 128. In the registration of NFp1 114a and NFp2 114b, new information of the External NF instance Id (NFp3) 128 is required for each instance, specifically:
External NF instance Id: new instance Id (NFp3).
(optionally) External NF instance name: a new name may be chosen for the External NF.
ExternalFQDN: The ExternalFQDN identifies the pSEPP (or alternatively an SCP in the pPLMN).
(optionally) TopologyHidding: a new flag to indicate whether this NF instance should be hidden from access by another PLMN.

Step 2: A Registration response is transmitted by the pNRF 108 to each NF instance 114a and 114b. Steps 3 and 4 are similar to steps 1 and 2 for another NF instance 114b.

Step 5: The NFc 122 (or alternatively the SCP 120) in the cPLMN 104 performs a discovery of suitable instances to provide a service. In the example, the NFc 122 is in a cPLMN and needs to access an NFp 114a or 114b in the pPLMN 102, then the cNRF 118 needs to get the NF profiles from the pNRF 108.

Step 6: The pNRF 108 identifies the request from a cNRF 118 and the pNRF 108 checks if topology hiding is required, by checking a) if the new data to perform topology hiding is included in the registration, or b) alternatively, a new flag may be included in the Registration to indicate topology hiding is required as described herein. If topology hiding is required, then the pNRF 108 shall provide a profile for each External NF identity that is registered, regardless of the number of NF instances that are registered. In the example, NFp3 128 is defined as external, to hide both NFp1 114a and NFp2 114b from view or access by the cPLMN 104.

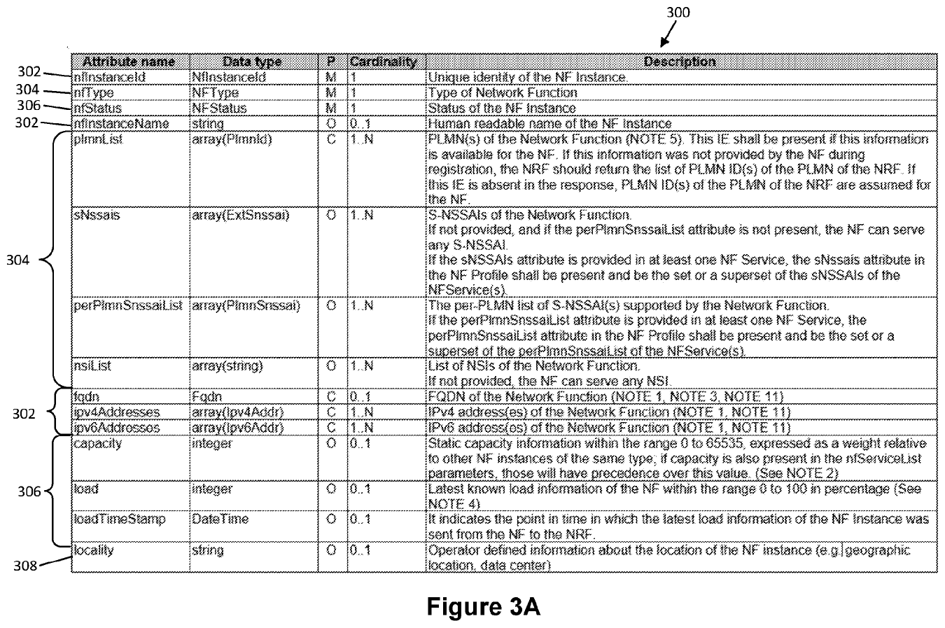

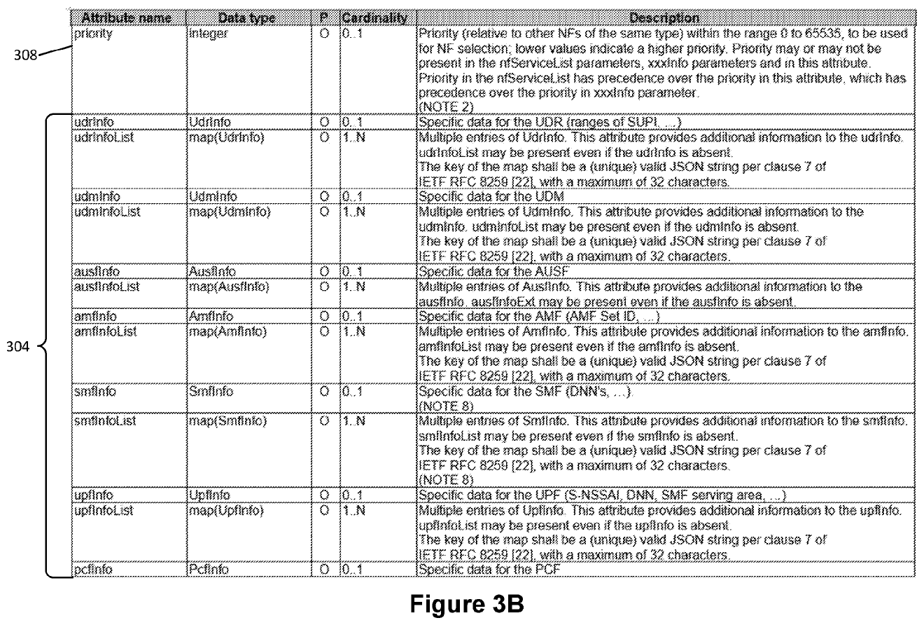

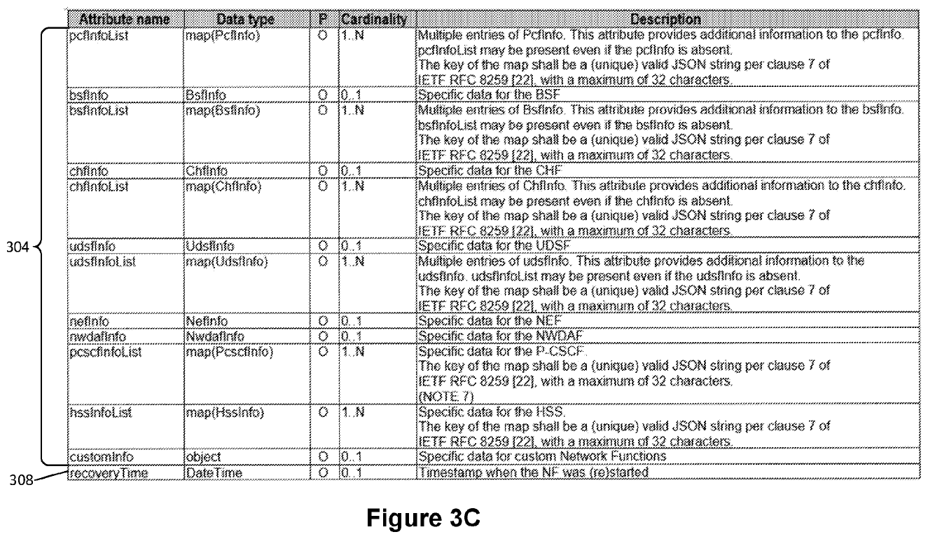

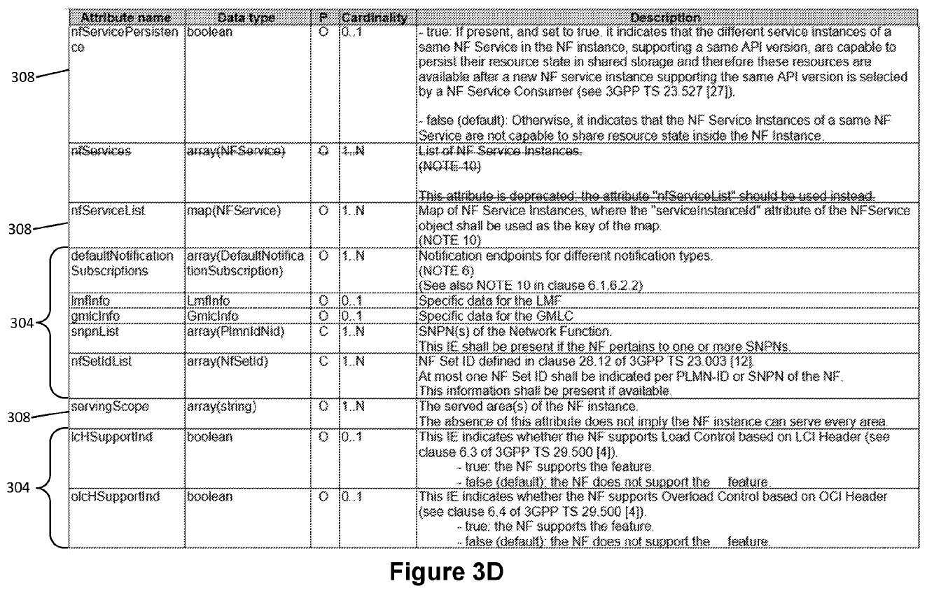

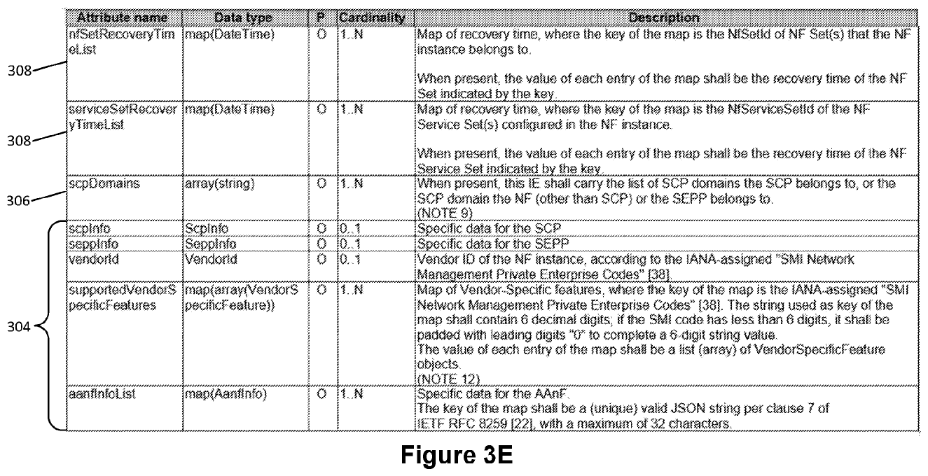

The pNRF 108 compounds an NF profile for the NFp3 128, considering different actions for the different attributes in the NF profile. FIGS. 3A-3E are a table including a NF profile 300 according to some embodiments of inventive concepts. Different action that are possible for each attribute in the NFp1 or NFp2 profile include:
The registered attribute keeps being valid in the “compound” NF profile, i.e., in the external NFp3 profile. This applies to the attributes that are common for all the instances that are functionally equivalent, e.g., when the instances belong to the same Set. These attributes correspond to reference numeral 304 in the data model for the NF profile 300 in FIG. 3.
The registered attribute is replaced by new defined attribute corresponding to reference numeral 302 in FIG. 3, this applies specifically to:
   NF instance Id is replaced by an External Instance Id.
   NF instance name is replaced by an External instance name.
   Fully Qualified Domain Name (FQDN) and InterPlmnFqdn are replaced by ExternalFQDN.
The registered attribute is omitted in the external profile if the attribute is not valid in the external NFp3 profile, e.g., locality, each NF instance of the Set may have a different value, and this is not used for selection in the cPLMN, but in the pPLMN. These attributes correspond to reference numeral 308 in FIG. 3.
The registered attribute needs to be modified to be adapted. For example, nfStatus. The registered attribute has to reflect REGISTERED status even if only one of the hidden NF instances is REGISTERED. Or SCP domains, that shall include all the SCP domains of all the NF instances that are hidden. These attributes correspond to reference numeral 306 in FIG. 3.

Step 7: A discovery response is transmitted from the pNRF 108 to the NFc 122. The discovery response includes only external NFp profiles. In the example in FIG. 1, the discovery response includes NFp3 128 with the “compound” NF profile.

Step 8: The NFc 122 selects a suitable NFp from the discovery results. In this case, the suitable NFp will be NFp3 128.

Referring also to FIGS. 2A and 2B, FIGS. 2A and 2B are a flow chart of an example of a method 200 for NF registration and topology hiding according to some embodiments of inventive concepts. At least some portions of the method 200 are implemented by a network node in a communications infrastructure that includes a plurality of Public Land Mobile Networks (PLMNs). At least some of the functions in the blocks in FIGS. 2A and 2B correspond to the steps illustrated in FIG. 1. The steps described with reference to FIG. 1 are included in the method 200. In block 202, the method 200 includes receiving a request from one or more NF instances for registration. Block 202 corresponds to Steps 1 and 3 in FIG. 1.

In block 204, the method 200 includes registering each NF instance that needs topology hiding by including external NF instance information in the registration. In block 206, registering each NF instance that needs topology hiding includes merging registered attributes in an NF profile of each NF instance into a compound external profile for the external NF instance, e.g., NFp3 128. Merging the attributes includes performing a particular action with respect to each attribute based on the attribute similar to that previously described with reference to FIG. 3. In accordance with some examples, the particular action includes one of: including the registered attribute in the compound external profile if the registered attribute would be valid in the compound external profile; replacing the registered attribute in the compound external profile if the registered attribute requires topology hiding; omitting the registered attribute from the compound external profile if the registered attribute would be invalid in the compound external profile; or modifying the registered attribute in the compound external profile similar to that previously described. Accordingly, registering each NF instance that needs topology hiding includes replacing an NF instance identification by an external instance identification and replacing a Fully Qualified Domain Name (FQDN) by an external FQDN. In some examples, registering each NF instance that needs topology hiding further includes replacing an NF instance name by an external instance name and/or associating a flag with the NF instance to indicate that the NF instance should be hidden from access from another PLMN.

In block 208, the method 200 includes transmitting a registration response to each NF instance. Block 208 corresponds to steps 3 and 4 in FIG. 1.

In block 210, the method 200 includes receiving an NF discovery request by the cNRF 118 of the cPLMN 104 from a network node of a cPLMN 104, e.g., NFc node 122 or SCP-x node 120 in FIG. 1. Block 210 corresponds to Step 5 in FIG. 1.

In block 212, the method 200 includes transmitting the NF discovery request to the pNRF 108 of the pPLMN 102. Block 210 corresponds to Steps 5a and 5b in FIG. 1.

In block 214, the method 200 includes receiving, by a Network Function Repository Function (pNRF) node 108 of a producer PLMN (pPLMN) 102, a network function (NF) discovery request for a particular service from a network node of a consumer PLMN (cPLMN), e.g., cNRF 118 in the example in FIG. 2.

In block 216, the method 200 includes determining, by the pNRF node 108, if topology hiding is required for a NF instance that provides the particular service. Block 216 corresponds to Step 6 in FIG. 1. In some examples, determining if topology hiding is required includes determining if a registration of the NF instance with the pNRF node 108 includes information for performing topology hiding or determining if the registration of the NF instance includes a flag indicating to perform topology hiding.

In block 218, the method 200 includes transmitting, by the pNRF node, a discovery response including one or more external NF instances. Each external NF instance includes one or more internal NF instances in a Set of NF instances of the pPLMN that require topology hiding from the cPLMN.

In block 220, the method 200 includes receiving the discovery response by the cNRF 118. The discovery response includes compound external NF profiles for each external NF identity registered in the pNRF 108 or locally configured by the pNRF 108 as described with reference to FIG. 4. Block 220 corresponds to Step 7 in FIG. 1.

In block 222, the method 200 includes selecting a suitable NF instance, e.g., external NF instance NFp3 128, from the discovery results. Block 222 corresponds to Step 8 in FIG. 1.

FIG. 4 is a signal or message flow diagram in a communication infrastructure 100 illustrating an example of configuration without registration and topology hiding according to some embodiments of inventive concepts. In some embodiments, the pNRF node 108 is configured to hide one or more Sets 112 of NF instances 114 to avoid new registrations similar to that described with reference to FIGS. 1 and 2A-2B. In such embodiments, the registration in FIG. 1 is replaced by local configuration in the pNRF node 108. Accordingly, in some embodiments, blocks 202-208 of the method 200 for performing registration are replaced by block 402 to include performing local configuration in the pNRF node 108 to provide topology hiding of at least some NF instances 114 in the Set 112 of NF instances using an external NF instance, e.g., NFp3 128. Performing local configuration in the pNRF node 108 includes replacing an NF instance identification by an external instance identification (NFp3) and replacing a Fully Qualified Domain Name (FQDN) by an external FQDN. In other embodiments, performing local configuration in the pNRF node 108 further, optionally, includes replacing an NF instance name by an external instance name and/or associating a flag with the NF instance to indicate that the NF instance should be hidden from access from another PLMN. Performing local configuration has the advantage of not modifying registration from NFps as well as the configuration of the topology hiding being centralized in the pNRF 108.

Steps 1-4 in FIG. 4 are similar to Steps 5-8 in FIG. 1 as described above.

In other embodiments, local configuration is performed in the pSEPP 106. In this case Step 2 (Step 6 in FIG. 1) of applying topology hiding is performed by the pSEPP 106.

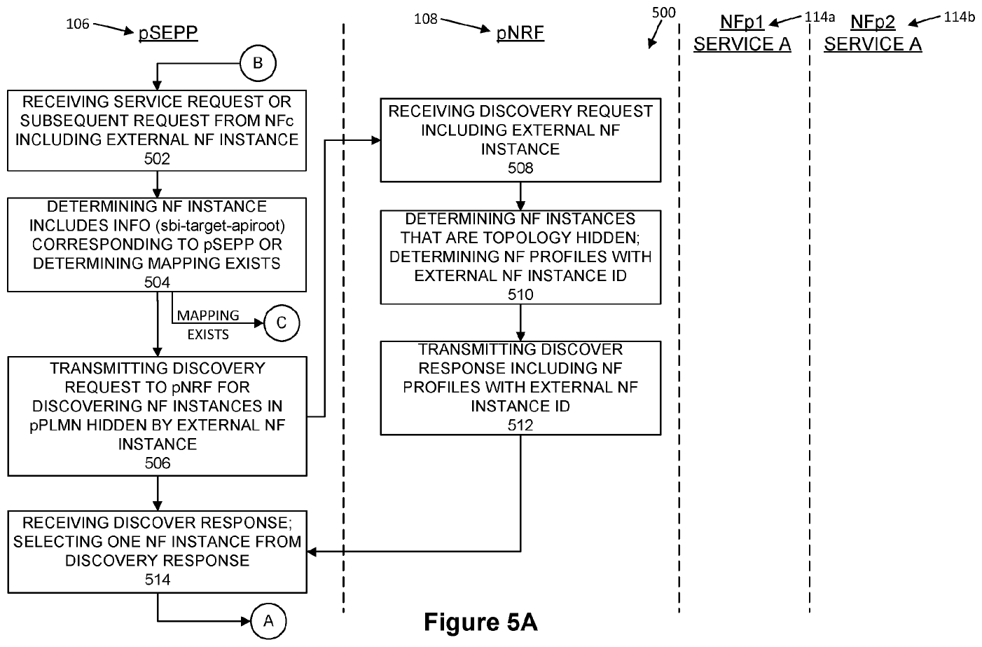

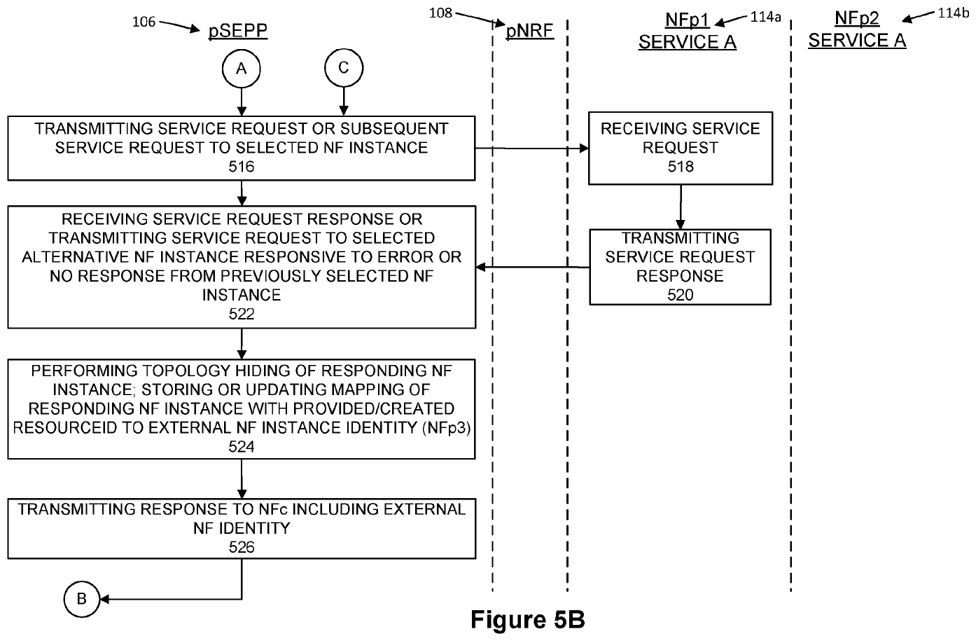

FIGS. 5A-5B are a flow chart of an example of a method 500 for topology hiding according to some embodiments of inventive concepts. In some embodiments, the method 500 is a continuation of the method 200 in FIG. 2. In accordance with some examples, the method 500 is implemented by network nodes, e.g., pSEPP node 106 and/or a pNRF node 108 in a communication infrastructure, e.g., communications infrastructure 100, that includes a plurality of public land mobile networks (PLMNs) 102 and 104. The exemplary method 500 includes functions (blocks) performed by different network nodes in a PLMN as shown in FIGS. 5A-5B.

In block 502, the method 500 includes receiving, by a Security Edge Protection Proxy (pSEPP) node 106 of a producer PLMN (pPLMN) 102, a request or a subsequent request for a particular service from a network node of a consumer PLMN (cPLMN) 104. The request or the subsequent request includes an external network function (NF) instance.

In block 504, the method 500 includes determining, by the pSEPP node 106, that the external NF instance include information (sbi-target-apiroot) corresponding to the pSEPP node 106 and that a destination is hidden in the request. As described herein, with respect to subsequent requests the method 500 includes determining if a mapping exists of a responding NF instance with a provided or created Resource identification (ResourceId) to the external NF instance identity, e.g., NFp3 128 of the responding NF instance. In some examples, the external NF instance identity is in a Hypertext Transfer Protocol (HTTP) header Location and the external NF instance identity hides a Uniform Resource Identifier (URI) of a resource providing the particular service.

In block 506, the method 500 includes transmitting, by the pSEPP node 106, a request to a NF Repository Function (pNFR) node 108 of the pPLMN for getting NF instances 114 in the pPLMN that are topology hidden by the external NF instance. In some examples, transmitting the request to the pNRF 108 for getting the NF instances that are topology hidden by the external NF instance includes transmitting a discovery request that uses the external NF instance as a key to get the NF instances that are topology hidden.

In block 508, the method 500 includes receiving, by the pNRF node 108, a discovery request from the pSEPP node 106. The discover request includes the external NF instance.

In block 510, the method 500 includes determining, by the pNRF node 108, NF instances that are topology hidden by the external NF instance. The pNRF node 108 determines the external NF instance is not real. Determining NF instances that are topology hidden by the external instance includes determining NF profiles with an external NF instance identification.

In block 512, the method 500 includes transmitting, by the pNRF node 108, a discovery response to the pSEPP node 106. The discovery response includes NF profiles of NF instances with external NF instance identifications.

In block 514, the method 500 includes receiving, by the pSEPP node 106, the discovery response from the pNFR node 108. The discovery response includes NF profiles of one or more NF instances that are topology hidden by the external NF instance. In block 514, the method 500 also includes selecting, by the pSEPP node 106, a selected NF instance from the one or more NF instances in the discovery response.

In block 516, the method 500 includes transmitting, by the pSEPP node 106, a service request to the selected NF instance of the one or more NF instances.

In block 518, the method 500 includes receiving, by the selected NF instance, the service request. In block 520, the method 500 includes transmitting, by the selected NF instance 114a (in the example in FIG. 5B), a service request response back to the pSEPP node 106.

In block 522, the method 500 includes receiving, by the pSEPP node 106, the service request response from the selected NF instance 114a. The selected NF instance that responds is a responding NF instance. In block 522, the method 500 also includes transmitting, by the pSEPP node 106, another service request to a selected alternative NF instance, e.g., NF instance 114b of the one or more NF instances in response to an error or no response from a previously selected NF instance. The pSEPP node 106 may continue to transmit the service request to selected alternate NF instances in a Set until a service request response is received from one of the NF instances in the Set or no service request response is received from any of the NF instances in the Set.

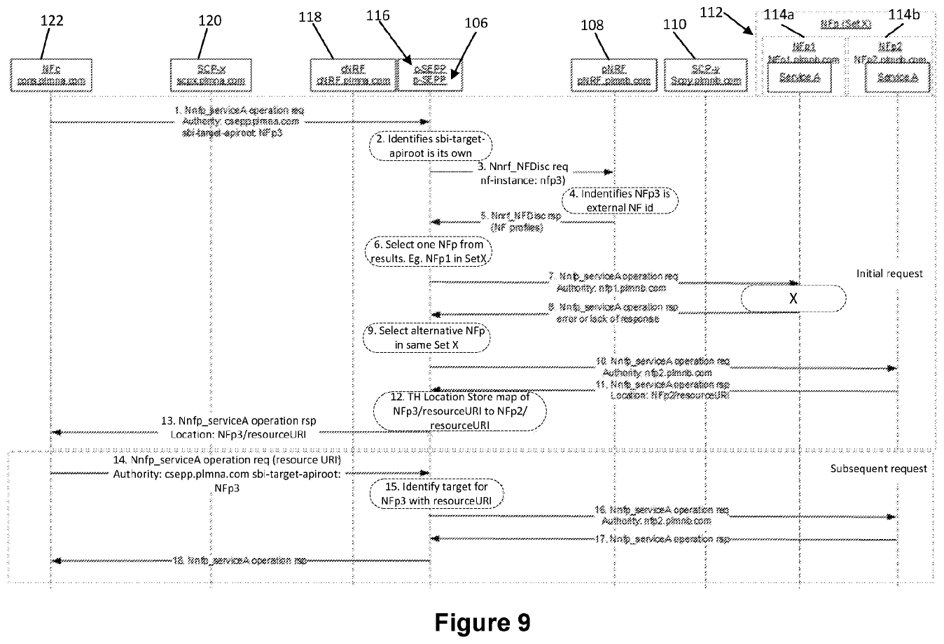

In block 524, the method 500 includes performing, by the pSEPP node 106, topology hiding of the responding NF instance in response to receiving the service request response. In block 524, the method 500 also includes storing, by the pSEPP node 106, a mapping of the responding NF instance with a provided or created Resource identification (ResourceId) to the external NF instance identity of the responding NF instance. An example of storing the mapping of the responding NF instance and processing subsequent service requested will be described with reference to FIG. 9.

In block 526, the method 500 includes transmitting, by the pSEPP node 106, a response to the network node (NFc 122 in FIG. 1) of the cPLMN. The response includes an external NF instance identity of the responding NF instance. The method 500 then returns to block 502 and the pSEPP node 106 may receive subsequent requests for the particular service.

Returning to block 502, the method 500 includes receiving, by the pSEPP node 106, a subsequent request for the particular service. The subsequent request including the external NF instance.

In block 504, the method 500 includes determining, by the pSEPP node 106, if a mapping of the responding NF instance (in block 522) exists with a provided or created Resource identification (ResourceId) to the external NF instance identity of the responding NF instance. The pSEPP node 106 treats the subsequent service request as a first service request in response to the mapping not existing. The method 500 advances to block 516 in response to the mapping existing.

In block 516, the method 500 includes transmitting, by the pSEPP node 106, the subsequent service request to the responding NF instance in response to the mapping existing. In blocks 518 and 520, the NF instance 114 receives the subsequent service request and transmits a subsequent service request response to the pSEPP node 106 similar to that previously described.

In block 522, the method 500 includes receiving, by the pSEPP node 106, the subsequent service response from the responding NF instance. Similar to that previously described, the method 500 includes transmitting, by the pSEPP node 106, the subsequent service request to a selected alternative NF instance of the one or more NF instances in response to an error or not receiving the subsequent service response from the NF instance 114. The pSEPP node 106 may continue to transmit the subsequent service request to selected alternate NF instances in a Set until a service request response is received from one of the NF instances in the Set or no service request response is received from any of the NF instances in the Set.

Similar to that previously described, in block 524, the method 500 includes performing, by the pSEPP node 106, topology hiding of the responding NF instance in response to receiving the subsequent service request response. The method 500 additionally includes updating, by the pSEPP node 106, the mapping in response to receiving the subsequent service response from a selected alternative NF instance.

In block 526, the method 500 includes transmitting, by the pSEPP node 106, the response to the network node of the cPLMN. The response transmitted by the pSEPP node 106 to the network node of the cPLMN includes either the external NF instance identity of the responding NF instance or the external NF instance identity of the selected alternative NF instance that responds to the subsequent service request.

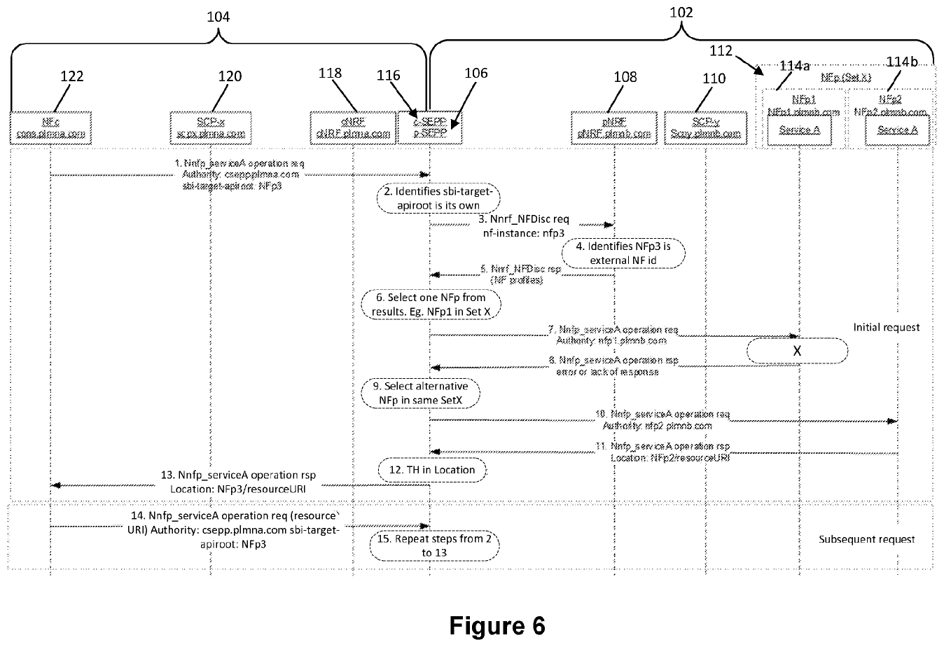

FIG. 6 is a signal or message flow diagram in a communication infrastructure illustrating an example of topology hiding implemented in a pSEPP node 106 of a pPLMN 102 according to some embodiments of inventive concepts. The steps described with reference to FIG. 6 correspond to at least some of the blocks in the method 500 and are considered to be included in the method 500. FIG. 6 is a continuation of FIG. 1.

Step 1: A service request for a particular service is sent by a network node (NFc) 122 of the cPLMN 104 to one of the discovered results (steps 126 in FIG. 1). In the example in FIG. 1, one of the discovered results is NFp3 128. The service request is received by the pSEPP 106.

Step 2: The pSEPP 106 identifies the sbi-target-apiroot corresponds to itself. The pSEPP 106 then identifies that the destination is hidden in the service request.

Step 3: The pSEPP 106 discover the NF instances 114 in the pPLMN 102 that are hidden by the received NFp3. For that, the pSEPP 106 uses the “external” NF id in the discovery request.

Step 4: The pNRF 108 identifies the NFp3 is not a “real” instance but the NFp3 corresponds to one of the “created external” instance identifiers. Then, the pNRF 108 finds the corresponding NF instances, searching for the NF profiles that include NFp3 in the new field “external NF instance Id”.

Step 5: The pNRF 108 provides identified NF profiles with External NF instance Id=NFp3.

Step 6: The pSEPP 106 selects one NFp from the provided results. This means that the pSEPP 106 performs initial selection within the hidden NF instances 114a, 114b (under the same external NF instance Id).

Step 7: A regular request is transmitted to the selected instance 114a. As illustrated in the example in FIG. 6, the selected NFp 114a is not available or unreachable for some reason as illustrated in the example in FIG. 6.

Step 8: An error or lack of response from the selected instance 114a occurs.

Step 9: The pSEPP 106 is able to select an alternative internal NFp instance 114b in the same Set 112 (if a Set is defined) or among all the results provided in Step 6.

Step 10: A regular request is sent to the newly selected alternative destination or NF instance 114b (NFp2) in the example in FIG. 6.

Step 12: The pSEPP 106 needs to hide the selected alternative NF instance 114b (NFp2) to the cPLMN 104. In this case, the pSEPP 106 needs to hide the Resource URI provided in the HTTP header Location, that is, the one used by the network node NFc 122 to identify the created resource. This identifies not only the ResourceId, that is common to all the NF instances in the Set, but also the path identifies the internal NF instance as well.

Step 13: The response is sent by the pSEPP 106 with the hidden Location (NFp3) to the network node NFc 122 in the cPLMN 104.

Step 14: A subsequent request for the service is sent to the received resource URI, including received apiroot in Location in sbi-target-apiroot.

Step 15: Steps 2-13 are repeated for subsequent requests for the service.

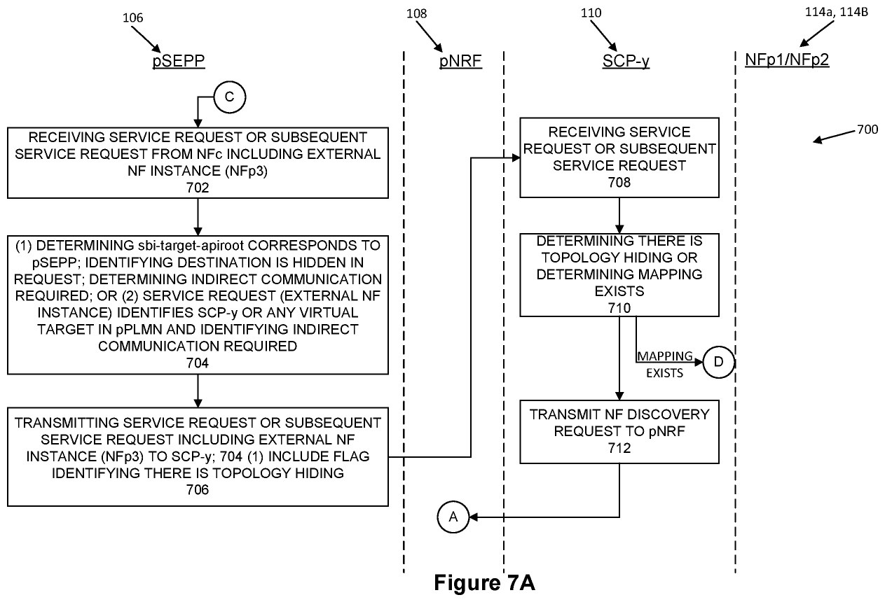

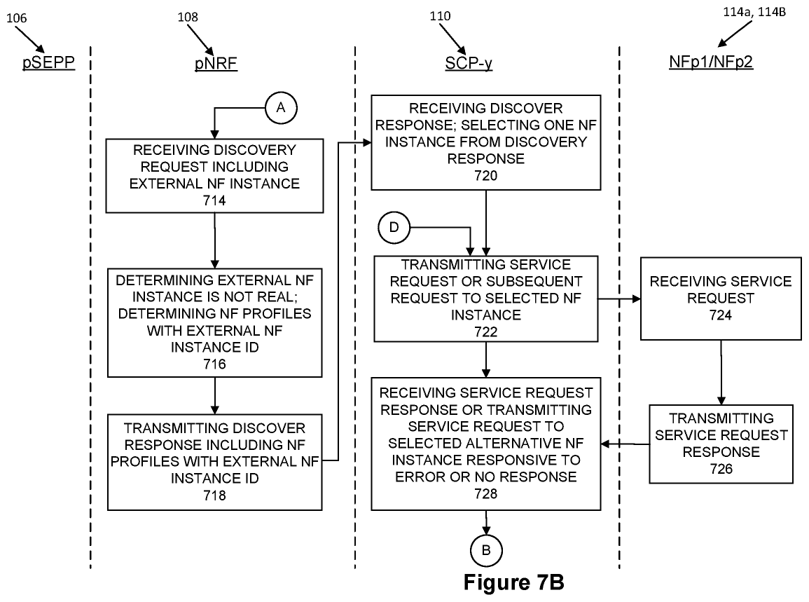

FIGS. 7A-7C are a flow chart of an example of a method 700 for topology hiding according to some embodiments of inventive concepts. The exemplary method 700 includes functions (blocks) performed by different network nodes in a pPLMN as shown in FIGS. 7A-7C. In block 702, the method 700 includes receiving, by a Security Edge Protection Proxy (pSEPP) node 106 of a producer PLMN (pPLMN) 102 a request for a particular service from a network node of a consumer PLMN (cPLMN) 104. The request includes an external network function (NF) instance.

In block 704, the method 700 includes performing one of:
(a) determining, by the pSEPP node 106, that the external NF instance includes information corresponding to the pSEPP node 106 and that the destination is hidden in the request, wherein the method further includes: determining, by the pSEPP node 106, that indirect communication is required; and transmitting (block 706) the request for the particular service to a Service Communication Proxy (pSCP or SCP-y) node 110 of the pPLMN, wherein the transmitted request includes a flag indicating there is topology hiding; or
(b) determining, by the pSEPP node 106, that the external NF instance identifies the pSCP node 110 or any virtual target of the pPLMN and identifies that indirect communication is required, wherein the method further includes transmitting (block 706) the request for the particular service to the pSCP 110.

In block 708, the method 700 includes receiving, by a Service Communication Proxy (pSCP) node 110 of a producer PLMN (pPLMN), a request or a subsequent request for a particular service from a pSEPP node 106 of the pPLMN 102. The request or the subsequent request comprises an external network function (NF) instance.

In block 710, the method 700 includes determining, by the pSCP node 110, there is topology hiding either based on a flag in the request indicating there is topology hiding or the pSCP node 110 is unable to find a received target as routable.

In block 712, the method 700 includes transmitting, by the pSCP node 110, an NF discovery request to a NF Repository Function (pNRF) node 108 of the pPLMN 102.

In block 714, the method 700 includes receiving, by the pNRF node 108, a discovery request from the pSCP node 110 of the pPLMN 102. The discover request includes the external NF instance.

In block 716, the method 700 includes determining, by the pNRF node 108, NF instances that are topology hidden by the external NF instance.

In block 718, the method 700 includes transmitting, by the pNRF node 108, a discovery response to the pSCP node 110. The discovery response includes NF profiles of NF instances with external NF instance identifications.

In block 720, the method 700 includes receiving, by the pSCP node 110, a discovery response from the pNRF node 108. The discovery response includes NF profiles of one or more NF instances 114 that are topology hidden by the external NF instance. In block 720, the method also includes selecting, by the pSCP node 110, a selected NF instance 114a or 114b from the one or more NF instances in the discovery response.

In block 722, the method 700 includes transmitting, by the pSCP node 110, a service request to the selected NF instance 114a or 114b of the one or more NF instances.

In block 724, the method 700 includes received the service request by the selected NF instance. In block 726, the method 700 includes transmitting a service request response to the pSCP node 110.

In block 728, the method 700 includes receiving, by the pSCP node 110, the service request response from the selected NF instance 114a or 14b. The selected NF instance that responds is a responding NF instance. In block 728, the method 700 includes transmitting, by the pSCP node 110, another service request to a selected alternative NF instance 114a or 114b of the one or more NF instances in response to an error or no response from a previously selected NF instance. The pSCP node 110 may continue to transmit service request to selected alternative NF instances in a Set until one of the NF instances responds or no response is received from any of the NF instances in the Set.

In block 730, the method 700 includes performing, by the pSCP node 110, topology hiding of the responding NF instance in response to receiving the service request response. In block 730, the method 700 also includes storing, by the pSCP node 110, a mapping of the responding NF instance with a provided or created Resource identification (ResourceId) to the external NF instance identity of the responding NF instance.

In block 732, the method 700 includes transmitting, by the pSCP node 110, a response to the pSEPP node 106, wherein the response includes an external NF instance identity of the responding NF instance. In some examples, the external NF instance identity is in a Hypertext Transfer Protocol (HTTP) header Location and the external NF instance identity hides a Uniform Resource Identifier (URI) of a resource providing the particular service.

In block 734, the method 700 includes receiving, by the pSEPP node 106, a response from the pSCP node 110 including the external NF instance identity for the NF instance in the pPLMN 102 providing the particular service.

In block 736, the method 700 includes transmitting, by the pSEPP node 106, the response including the external NF instance identity to the network node of the cPLMN 104. The method 700 then returns to block 702 and the pSEPP 106 may receive subsequent service requests. The method 700 may then continue similar to that previously described for each subsequent service request. For example, in block 708, the method 700 includes receiving, by the pSCP node 110, the subsequent request for the particular service from the pSEPP node 106. The subsequent request includes the external NF instance.

In block 710, the method 700 includes determining, by the pSCP node 110, if a mapping of the responding NF instance exists with a provided or created Resource identification (ResourceId) to the external NF instance identity of the responding NF instance. If mapping exists, the method 700 advances to block 722. The pSCP 110 treats the subsequent service request as a first service request in response to the mapping not existing.

In block 722, the method 700 includes transmitting, by the pSCP node 110, a subsequent service request to the responding NF instance 114a or 114b in response to the mapping existing. In block 724, the NF instance receives the service request and in block 726 the NF instance transmits a service request response to the pSCP node 110 similar to that previously described.

In block 728, the method 700 includes receiving, by the pSCP node 110, a subsequent service response from the responding NF instance. If the pSCP node 110 does not receive a subsequent service response, in block 728, the method 700 includes transmitting, by the pSCP node 110, the subsequent service request to a selected alternative NF instance 114a or 114b of the one or more NF instances in response to an error or not receiving the subsequent service response. As previously described, the pSCP 110 may continue to transmit the subsequent service request to other alternative NF instances in a Set until one responds, or no response is received from any of the NF instances in the Set.

In block 730, the method 700 includes updating, by the pSCP node 110, the mapping in response to receiving the subsequent service response from the selected alternative NF instance 114a or 114b.

In block 732, the method includes transmitting, by the pSCP node 110, the response to the pSEPP node 106. The method 700 then continues similar to that previously described.

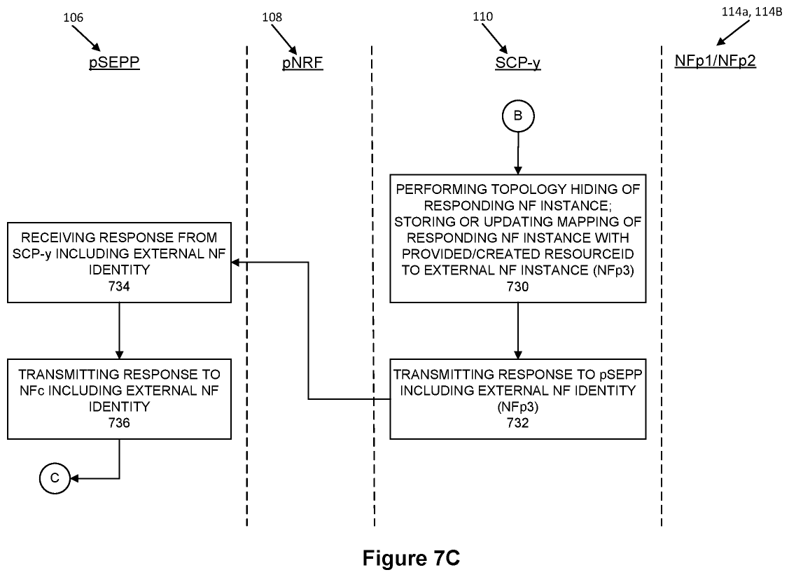

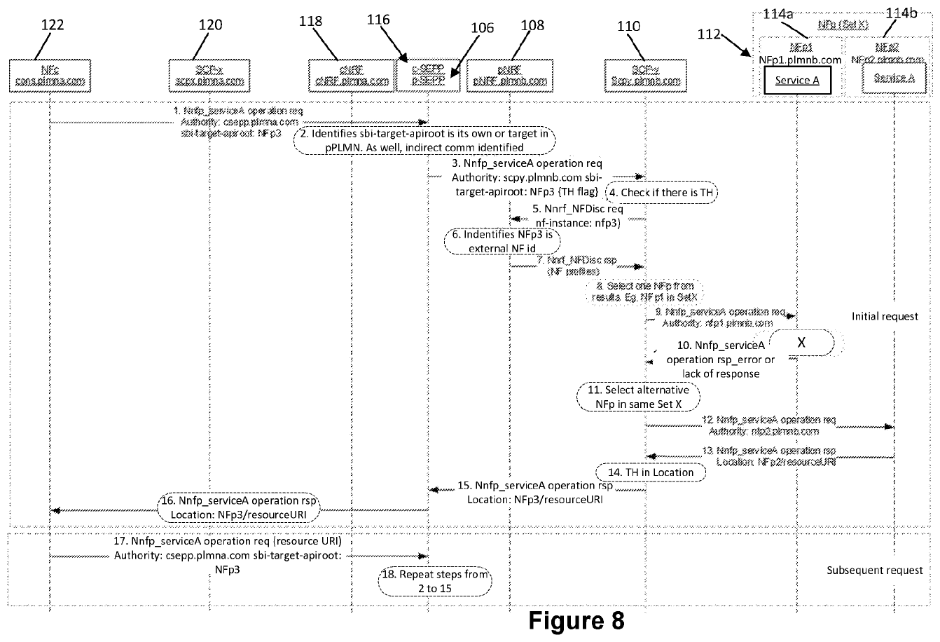

FIG. 8 is a signal or message flow diagram in a communication infrastructure illustrating an example of topology hiding implemented in a SCP node 110 of a pPLMN 102 according to some embodiments of inventive concepts. The steps described with reference to FIG. 8 correspond to at least some of the blocks in the method 700 and are considered to be included in the method 700. FIG. 8 is also a continuation of FIG. 1.

Step 1: Similar to Step 1 in FIG. 6. The pSEPP receives a request for a particular service

Step 2: There are two variants for this step:
a) The pSEPP 106 identifies the sbi-target-apiroot information in the request corresponds to itself, then the pSEPP 106 identifies that the destination is hidden in the request. The pSEPP 106 also identifies indirect communication is required. The pSEPP 106 forwards the request to the corresponding SCP-y (pSCP) 110. The pSEPP 106 includes a new flag that indicates that there is Topology Hiding (TH).
b) Alternatively, NFp3 may identify the SCP-y 110, or any “virtual” target in the pPLMN 102. The pSEPP 106 also identifies indirect communication is required. Then, the pSEPP 106 forwards the request to the corresponding SCP-y 110.

Step 3: The service request is sent to SCP-y 110. In case of Step 2 a), the service request can include the new flag.

Step 4: The SCP-y 110 identifies there is Topology Hiding (TH), either based on the new flag provided, or the SCP-y 110 is unable to find the received target as routable.

Steps 5 to 18 correspond to Steps 3 to 15 in FIG. 6 except Steps or actions performed by the pSEPP 106 in FIG. 6 are performed by the SCP-y 110 or pSCP in FIG. 8.

FIG. 9 is a signal or message flow diagram in a communication infrastructure illustrating an example of a variant of receiving a subsequent request for a service by a pSEPP 106 according to some embodiments of inventive concepts. The variant for subsequent request illustrated in FIG. 7 are valid for the examples shown in FIGS. 6 and 8 with some differences. The ResourceId is used to identify the NFp instance selected in the initial request and is used to select the same for subsequent requests. This logic is based on the fact that the ResourceId is unique in the Set. Steps 3-11 of FIG. 9 are the same as FIG. 6 described above.

Step 12: The pSEPP 106 stores the mapping of the selected NFp 114a or 114b with the provided/created ResourceId to the external NFp3 similar to that previously described.

Steps 13 and 14: Same as Steps 13 and 14 in FIG. 6.

Step 15: When the request is received towards an external NFp, pSEPP 106 determines if a mapping exists. If the mapping exists and it corresponds to a subsequent request, then the previously selected target or NF instance is used. In the example in FIG. 9, the selected target is NFp2 114b.

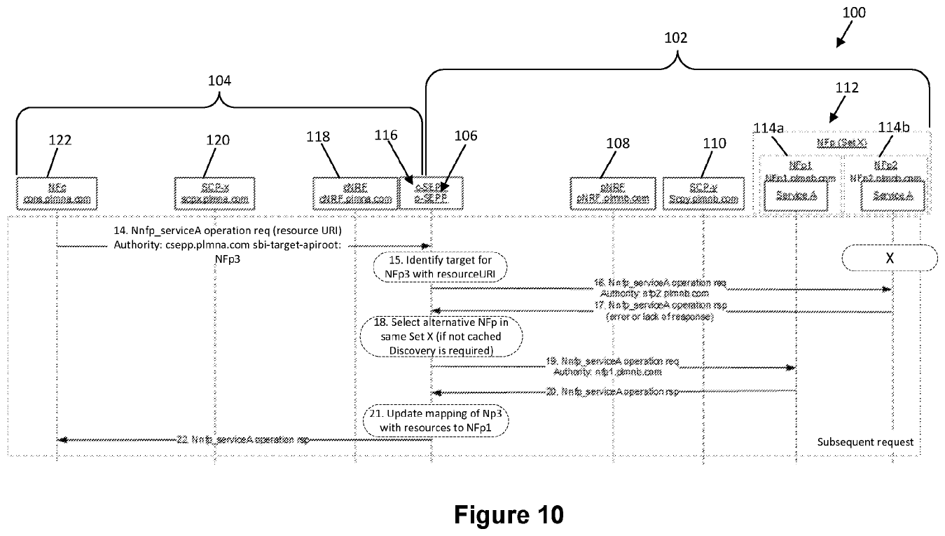

FIG. 10 is a signal or message flow diagram in a communication infrastructure illustrating an example of the variant in FIG. 9 including selecting an alternative NF instance 114a or 114b of a Set 112 according to some embodiments of inventive concepts.

Steps 14 and 15: Same as Steps 14 and 15 in FIG. 9.

Step 17: NFp2 114b is not reachable.

Step 18: The pSEPP 106 selects a new NFp instance in the same SetX 112. The information of the instances in the SetX is either cached or will be obtained from the pNRF 108 using NFp3 (external NF instance) as input.

Step 19, 20: New successful request to a newly selected NF instance (NFp1) 114a in SetX 112, to the same resource that was created before, that is accessible by all the NF instances in the Set.

Step 21: The pSEPP 106 updates the mapping of NFp3 (external NF instance) for this ResourceId, to the newly selected NF instance, NFp1 114a in the example in FIG. 10.

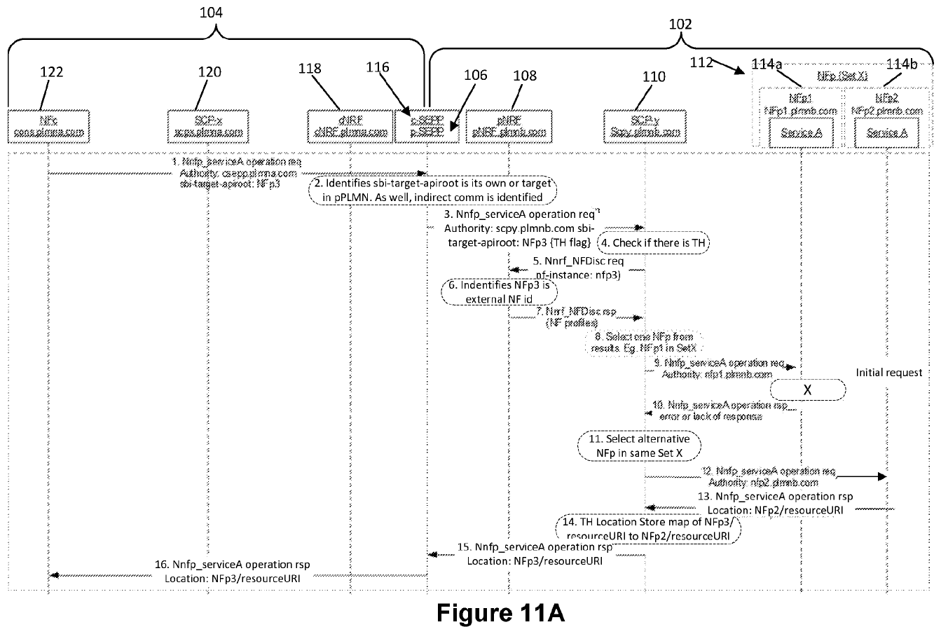

FIGS. 11A and 11B are a signal or message flow diagram in a communication infrastructure illustrating an example of a variant of receiving a subsequent request for a service by a SCP according to some embodiments of inventive concepts. The Steps illustrated in FIGS. 11A and 11B are similar to the Steps illustrated in FIG. 8 with the following additions:

Step 14: The SCP 110 stores the mapping of the selected NF instance (NFp1 or NFp2) 114a or 114b with the provided/created ResourceId to the external NF instance (NFp3).

Step 20: When the request is received towards an external NFp, it is checked if a mapping exists. If a mapping exists, it corresponds to a subsequent request, then the previously selected target (NF instance 114a or 114b) is used. In the example in FIGS. 11A and 11B, the selected target or NF instance is NFp2 114b.

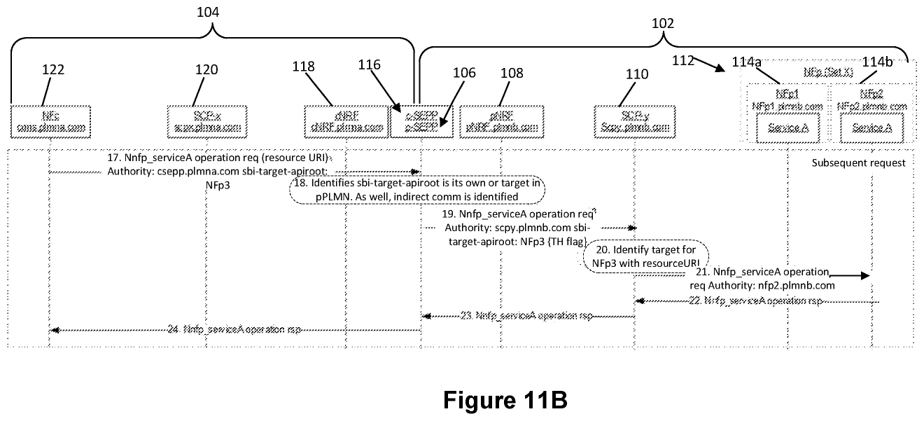

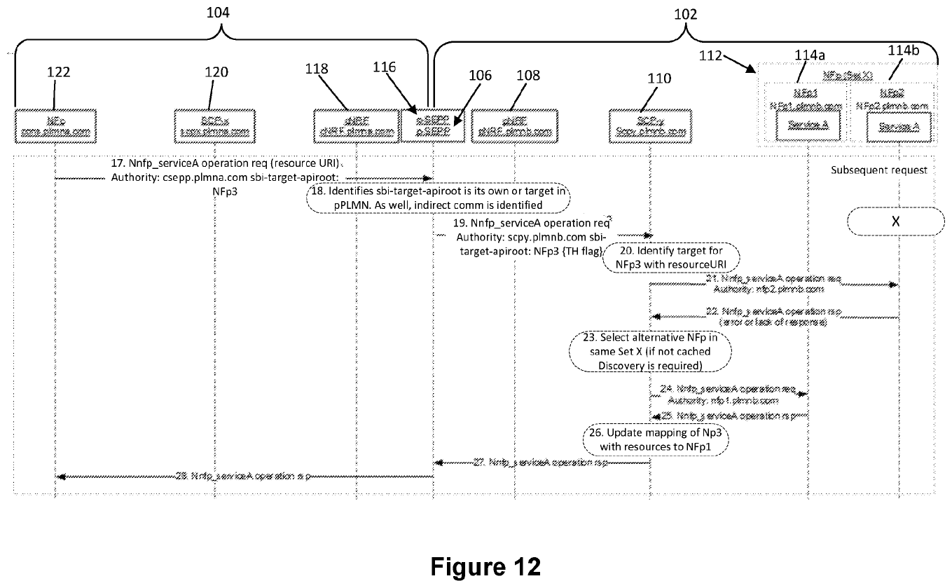

FIG. 12 is a signal or message flow diagram in a communication infrastructure illustrating an example of the variant in FIGS. 11A and 11B including selecting an alternative NF instance 114a or 114b of a Set 112 according to some embodiments of inventive concepts. The Steps in FIG. 12 are similar to the Steps in FIGS. 11A and 11B with the following differences:

Step 22: NFp2 instance 114b is not reachable.

Step 23: The SCP 110 selects a new NFp instance in the same SetX 112. The information of the instances in the SetX is either cached or will be obtained from the NRF 108 using the external NF instance identify (NFp3) as input.

Step 24, 25: A new successful request to a newly selected NFp1 114a in SetX 112, to the same resource that was created before, that is accessible by all the NF instances in the Set.

Step 26: the SCP 110 updates the mapping of NFp3 for this ResourceId, to the newly selected NFp2 114b.

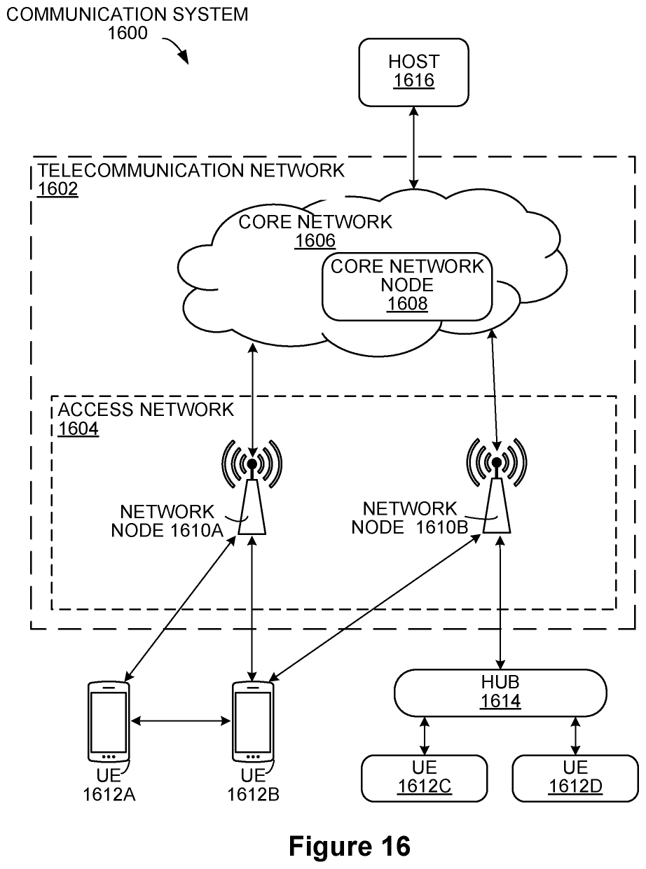

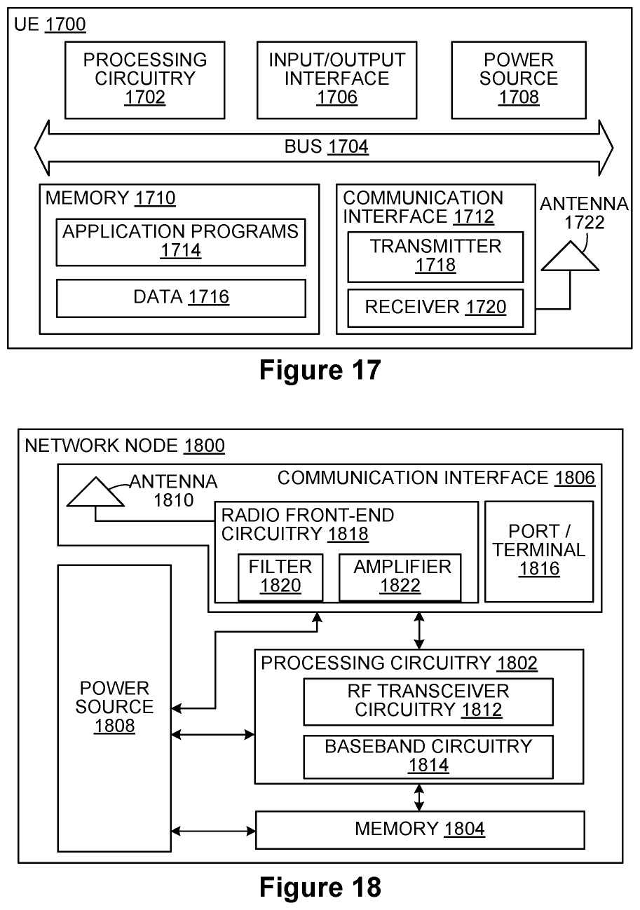

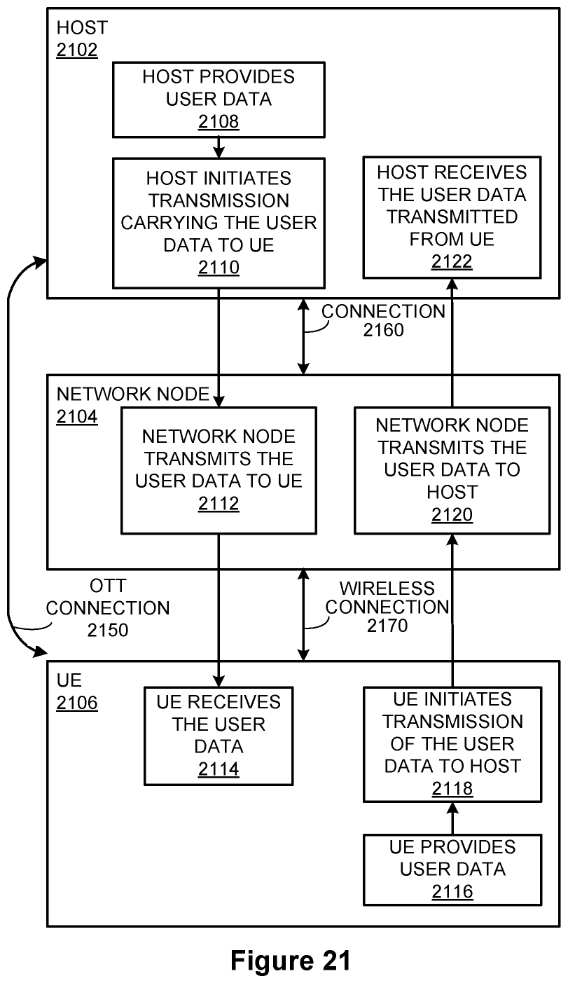

FIG. 13 is a block diagram illustrating elements of a communication device UE 600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 1300 may be provided, for example, as discussed below with respect to wireless devices UE 1612A, UE 1612B, and wired or wireless devices UE 1612C, UE 1612D of FIG. 16, UE 1700 of FIG. 17, virtualization hardware 2004 and virtual machines 2008A, 2008B of FIG. 20, and UE 2106 of FIG. 21, all of which should be considered interchangeable in the examples and embodiments described herein and be within the intended scope of this disclosure, unless otherwise noted.) As shown, communication device UE may include an antenna 1307 (e.g., corresponding to antenna 1722 of FIG. 17), and transceiver circuitry 1301 (also referred to as a transceiver, e.g., corresponding to interface 1712 of FIG. 17 having transmitter 1718 and receiver 1720) including a transmitter and a receiver configured to provide uplink and downlink radio communications with a base station(s) (e.g., corresponding to network node 1610A, 1610B of FIG. 16, network node 1800 of FIG. 18, and network node 2104 of FIG. 21 also referred to as a RAN node) of a radio access network. Communication device UE may also include processing circuitry 1303 (also referred to as a processor, e.g., corresponding to processing circuitry 1702 of FIG. 17, and control system 2012 of FIG. 20) coupled to the transceiver circuitry, and memory circuitry 1305 (also referred to as memory, e.g., corresponding to memory 1710 of FIG. 16) coupled to the processing circuitry. The memory circuitry 1305 may include computer readable program code that when executed by the processing circuitry 1303 causes the processing circuitry to perform operations according to embodiments disclosed herein. According to other embodiments, processing circuitry 1303 may be defined to include memory so that separate memory circuitry is not required. Communication device UE may also include an interface (such as a user interface) coupled with processing circuitry 1303, and/or communication device UE may be incorporated in a vehicle.

As discussed herein, operations of communication device UE may be performed by processing circuitry 1303 and/or transceiver circuitry 1301. For example, processing circuitry 1303 may control transceiver circuitry 1301 to transmit communications through transceiver circuitry 1301 over a radio interface to a radio access network node (also referred to as a base station) and/or to receive communications through transceiver circuitry 1301 from a RAN node over a radio interface. Moreover, modules may be stored in memory circuitry 1305, and these modules may provide instructions so that when instructions of a module are executed by processing circuitry 1303, processing circuitry 1303 performs respective operations (e.g., operations discussed below with respect to Example Embodiments relating to wireless communication devices). According to some embodiments, a communication device UE 1300 and/or an element(s)/function(s) thereof may be embodied as a virtual node/nodes and/or a virtual machine/machines.

FIG. 14 is a block diagram illustrating elements of a radio access network RAN node 1400 (also referred to as a network node, base station, eNodeB/eNB, gNodeB/gNB, etc.) of a Radio Access Network (RAN) configured to provide cellular communication according to embodiments of inventive concepts. (RAN node 1400 may be provided, for example, as discussed below with respect to network node 1610A, 1610B of FIG. 16, network node 1800 of FIG. 18, hardware 2004 or virtual machine 2008A, 2008B of FIG. 20, and/or base station 2104 of FIG. 21, all of which should be considered interchangeable in the examples and embodiments described herein and be within the intended scope of this disclosure, unless otherwise noted.) As shown, the RAN node may include transceiver circuitry 1401 (also referred to as a transceiver, e.g., corresponding to portions of RF transceiver circuitry 1812 and radio front end circuitry 1818 of FIG. 18) including a transmitter and a receiver configured to provide uplink and downlink radio communications with mobile terminals. The RAN node may include network interface circuitry 1407 (also referred to as a network interface, e.g., corresponding to portions of communication interface 1806 of FIG. 18) configured to provide communications with other nodes (e.g., with other base stations) of the RAN and/or core network CN. The network node may also include processing circuitry 1403 (also referred to as a processor, e.g., corresponding to processing circuitry 1802 of FIG. 18) coupled to the transceiver circuitry, and memory circuitry 1405 (also referred to as memory, e.g., corresponding to memory 1804 of FIG. 18) coupled to the processing circuitry. The memory circuitry 1405 may include computer readable program code that when executed by the processing circuitry 1403 causes the processing circuitry to perform operations according to embodiments disclosed herein. According to other embodiments, processing circuitry 1403 may be defined to include memory so that a separate memory circuitry is not required.

As discussed herein, operations of the RAN node may be performed by processing circuitry 1403, network interface 1407, and/or transceiver 1401. For example, processing circuitry 1403 may control transceiver 1401 to transmit downlink communications through transceiver 1401 over a radio interface to one or more mobile terminals UEs and/or to receive uplink communications through transceiver 1401 from one or more mobile terminals UEs over a radio interface. Similarly, processing circuitry 1403 may control network interface 407 to transmit communications through network interface 1407 to one or more other network nodes and/or to receive communications through network interface from one or more other network nodes. Moreover, modules may be stored in memory 1405, and these modules may provide instructions so that when instructions of a module are executed by processing circuitry 1403, processing circuitry 1403 performs respective operations (e.g., operations discussed below with respect to Example Embodiments relating to RAN nodes). According to some embodiments, RAN node 1400 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 15 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 1500 may be provided, for example, as discussed below with respect to core network node 1608 of FIG. 16, hardware 2004 or virtual machine 2008A, 2008B of FIG. 20, all of which should be considered interchangeable in the examples and embodiments described herein and be within the intended scope of this disclosure, unless otherwise noted) As shown, the CN node may include network interface circuitry 1507 configured to provide communications with other nodes of the core network and/or the radio access network RAN. The CN node may also include a processing circuitry 1503 (also referred to as a processor,) coupled to the network interface circuitry, and memory circuitry 1505 (also referred to as memory) coupled to the processing circuitry. The memory circuitry 1505 may include computer readable program code that when executed by the processing circuitry 1503 causes the processing circuitry to perform operations according to embodiments disclosed herein. According to other embodiments, processing circuitry 1503 may be defined to include memory so that a separate memory circuitry is not required.

As discussed herein, operations of the CN node may be performed by processing circuitry 1503 and/or network interface circuitry 1507. For example, processing circuitry 1503 may control network interface circuitry 1507 to transmit communications through network interface circuitry 1507 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to core network nodes). According to some embodiments, CN node 500 and/or an element(s)/function(s) thereof may be embodied as a virtual node/nodes and/or a virtual machine/machines.

In the description that follows, while the communication device may be any of the communication device 600, wireless device 1612A, 1612B, wired or wireless devices UE 1612C, UE 1612D, UE 1700, virtualization hardware 2004, virtual machines 2008A, 2008B, or UE 2106, the communication device 300 shall be used to describe the functionality of the operations of the communication device. Operations of the communication device 300 (implemented using the structure of the block diagram of FIG. 6) will now be discussed with reference to the flow chart of Figure _ according to some embodiments of inventive concepts. For example, modules may be stored in memory 305 of FIG. 6, and these modules may provide instructions so that when the instructions of a module are executed by respective communication device processing circuitry 303, processing circuitry 303 performs respective operations of the flow chart.

In the description that follows, while the network node may be any of the RAN node 700, network node 1610A, 1610B, 1800, 2106, hardware 2004, or virtual machine 2008A, 2008B, the RAN node 700 shall be used to describe the functionality of the operations of the network node. Operations of the RAN node 1400 (implemented using the structure of FIG. 14) will now be discussed with reference to the flow chart of Figure _ according to some embodiments of inventive concepts. For example, modules may be stored in memory 1405 of FIG. 14, and these modules may provide instructions so that when the instructions of a module are executed by respective RAN node processing circuitry 703, processing circuitry 703 performs respective operations of the flow chart.

In the description that follows, while the core network node may be any of the core network node 1500, core network node 1608, hardware 2004, or virtual machine 2008A, 2008B, the core network node 1500 shall be used to describe the functionality of the operations of the network node. Operations of the Core Network CN node 1500 (implemented using the structure of FIG. 15) will now be discussed with reference to the flow chart of Figure _ according to some embodiments of inventive concepts. For example, modules may be stored in memory 1505 of FIG. 15, and these modules may provide instructions so that when the instructions of a module are executed by respective CN node processing circuitry 1503, processing circuitry 1503 performs respective operations of the flow chart.

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3rd Generation Partnership Project (3GPP) access node or non-3GPP access point. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software, or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part, or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all, or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

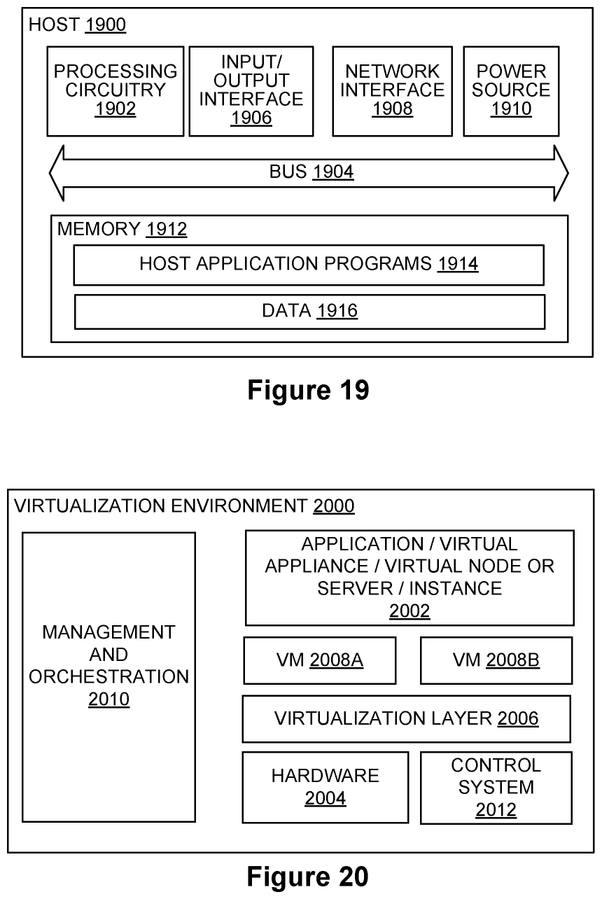

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g., such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency, and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information, or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof. Furthermore, as used herein, the common abbreviation “e.g.,”, which derives from the Latin phrase “exempli gratia,” may be used to introduce or specify a general example or examples of a previously mentioned item, and is not intended to be limiting of such item. The common abbreviation “i.e.,”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

### Embodiments

1. A method implemented by a network node in a communication infrastructure, that includes a plurality of Public Land Mobile Networks (PLMNs), the method comprising:
   receiving, by a Network Function Repository Function (pNRF) node of a producer PLMN (pPLMN), a network function (NF) discovery request for a particular service from a network node of a consumer PLMN (cPLMN);
   determining, by the pNRF node, if topology hiding is required for a NF instance that provides the particular service; and
   transmitting, by the pNRF node, a discovery response comprising one or more external NF instances, wherein each external NF instance comprises one or more internal NF instances in a Set of NF instances of the pPLMN that require topology hiding from the cPLMN.
2. The method of embodiment 1, wherein determining if topology hiding is required comprises:
   determining if a registration of the NF instance with the pNRF node comprises information for performing topology hiding; or
   determining if the registration of the NF instance comprises a flag indicating to perform topology hiding.
3. The method of any of embodiments 1-2, further comprising receiving a request from one or more NF instances for registration.
4. The method of embodiment 3, further comprising registering each NF instance that needs topology hiding by including external NF instance information in the registration.
5. The method of embodiment 4, wherein registering each NF instance that needs topology hiding comprises merging registered attributes in an NF profile of each NF instance into a compound external profile for the external NF instance.
6. The method of embodiment 5, wherein merging the attributes comprises performing a particular action with respect to each attribute based on the attribute.
7. The method of embodiment 6, wherein the particular action comprises one of:
   including the registered attribute in the compound external profile if the registered attribute would be valid in the compound external profile;
   replacing the registered attribute in the compound external profile if the registered attribute requires topology hiding;
   omitting the registered attribute from the compound external profile if the registered attribute would be invalid in the compound external profile; or modifying the registered attribute in the compound external profile.
8. The method of any of embodiments 4-7, wherein registering each NF instance that needs topology hiding comprises:
   replacing an NF instance identification by an external instance identification; and
   replacing a Fully Qualified Domain Name (FQDN) by an external FQDN.
9. The method of embodiment 8, wherein registering each NF instance that needs topology hiding further includes:
   replacing an NF instance name by an external instance name; and/or
   associating a flag with the NF instance to indicate that the NF instance should be hidden from access from another PLMN.
10. The method of embodiment 1, further comprising performing local configuration in the pNRF node to provide topology hiding of at least some NF instances in the Set of NF instances using the external NF instance.
11. The method of embodiment 10, wherein performing local configuration in the pNRF node comprises:
   replacing an NF instance identification by an external instance identification; and
   replacing a Fully Qualified Domain Name (FQDN) by an external FQDN.
12. The method of embodiment 11, wherein performing local configuration in the pNRF node further comprises:
   replacing an NF instance name by an external instance name; and/or
   associating a flag with the NF instance to indicate that the NF instance should be hidden from access from another PLMN.
13. The method of any of embodiments 1-12, further comprising:
   receiving, by the pNRF node, a discovery request from a Security Edge Protection Proxy (pSEPP) node of the pPLMN, wherein the discover request comprises the external NF instance;
   determining, by the pNRF node, NF instances that are topology hidden by the external NF instance; and
   transmitting, by the pNRF node, a discovery response to the pSEPP node, wherein the discovery response comprises NF profiles of NF instances with external NF instance identifications.
14. A method implemented by a network node in a communication infrastructure, that includes a plurality of public land mobile networks (PLMNs), the method comprising:
   receiving, by a Security Edge Protection Proxy (pSEPP) node of a producer PLMN (pPLMN), a request or a subsequent request for a particular service from a network node of a consumer PLMN (cPLMN), wherein the request or the subsequent request comprises an external network function (NF) instance;
   determining, by the pSEPP node, that the external NF instance comprises information corresponding to the pSEPP node and that a destination is hidden in the request;
   transmitting, by the pSEPP node, a request to a NF Repository Function (pNFR) node of the pPLMN for getting NF instances in the pPLMN that are topology hidden by the external NF instance;
   receiving, by the pSEPP node, a discovery response from the pNFR node, the discovery response comprising NF profiles of one or more NF instances that are topology hidden by the external NF instance;
   selecting, by the pSEPP node, a selected NF instance from the one or more NF instances in the discovery response;
   transmitting, by the pSEPP node, a service request to the selected NF instance of the one or more NF instances;
   receiving, by the pSEPP node, a service request response from the selected NF instance, wherein the selected NF instance that responds is a responding NF instance;
   performing, by the pSEPP node, topology hiding of the responding NF instance in response to receiving the service request response; and
   transmitting, by the pSEPP node, a response to the network node of the cPLMN, wherein the response comprises an external NF instance identity of the responding NF instance.
15. The method of embodiment 14, wherein transmitting the request to the pNRF for getting the NF instances in the pPLMN that are topology hidden by the external NF instance comprises transmitting a discovery request that uses the external NF instance as a key to get the NF instances that are topology hidden.
16. The method of embodiment 14, wherein the external NF instance identity is in a Hypertext Transfer Protocol (HTTP) header Location and the external NF instance identity hides a Uniform Resource Identifier (URI) of a resource providing the particular service.
17. The method of embodiment 14, further comprising transmitting, by the pSEPP node, another service request to a selected alternative NF instance of the one or more NF instances in response to an error or no response from a previously selected NF instance.
18. The method of any of embodiments 14-17, further comprising storing, by the pSEPP node, a mapping of the responding NF instance with a provided or created Resource identification (ResourceId) to the external NF instance identity of the responding NF instance.
19. The method of any of embodiments 14-18, further comprising:
   receiving, by the pSEPP node, the subsequent request for the particular service, wherein the subsequent request comprises the external NF instance;
   determining, by the pSEPP node, if a mapping of the responding NF instance exists with a provided or created Resource identification (ResourceId) to the external NF instance identity of the responding NF instance;
   transmitting, by the pSEPP node, the subsequent service request to the responding NF instance in response to the mapping existing, wherein the pSEPP treats the subsequent service request as a first service request in response to the mapping not existing;
   receiving, by the pSEPP node, a subsequent service response from the responding NF instance; and
   transmitting, by the pSEPP node, the response to the network node of the cPLMN.
20. The method of embodiment 19, further comprising transmitting, by the pSEPP node, the subsequent service request to a selected alternative NF instance of the one or more NF instances in response to an error or not receiving the subsequent service response.
21. The method of embodiment 20, further comprising updating, by the pSEPP node, the mapping in response to receiving the subsequent service response from the selected alternative NF instance.
22. The method of embodiment 21, wherein the response transmitted by the pSEPP node to the network node of the cPLMN comprises the external NF instance identity of the responding NF instance or the external NF instance identity of the selected alternative NF instance that responds to the subsequent service request.
22. A method implemented by a network node in a communication infrastructure, that includes a plurality of public land mobile networks (PLMNs), the method comprising:
   receiving, by a Security Edge Protection Proxy (pSEPP) node of a producer PLMN (pPLMN) a request for a particular service from a network node of a consumer PLMN (cPLMN), wherein the request comprises an external network function (NF) instance;
   performing one of:
   (a) determining, by the pSEPP node, that the external NF instance comprises information corresponding to the pSEPP node and that the destination is hidden in the request, wherein the method further comprises:
      determining, by the pSEPP node, that indirect communication is required; and
      transmitting the request for the particular service to a Service Communication Proxy (pSCP) node of the pPLMN, wherein the transmitted request comprises a flag indicating there is topology hiding; or
   (b) determining, by the pSEPP node, that the external NF instance identifies the pSCP node or any virtual target of the pPLMN and identifies that indirect communication is required, wherein the method further comprises transmitting the request for the particular service to the pSCP.
23. The method of embodiment 22, further comprising:
   receiving, by the pSEPP node, a response from the pSCP node comprising an external NF instance identity for an NF instance in the pPLMN for providing the particular service; and
   transmitting, by the pSEPP node, the response comprising the external NF instance identity to the network node of the cPLMN.
24. A method implemented by a network node in a communication infrastructure, that includes a plurality of public land mobile networks (PLMNs), the method comprising:
   receiving, by a Service Communication Proxy (pSCP) node of a producer PLMN (pPLMN), a request or a subsequent request for a particular service from a pSEPP node of the pPLMN, wherein the request or the subsequent request comprises an external network function (NF) instance;
   determining, by the pSCP node, there is topology hiding either based on a flag in the request indicating there is topology hiding or the pSCP node is unable to find a received target as routable;
   transmitting, by the pSCP node, an NF discovery request to a NF Repository Function (pNRF) node of the pPLMN;
   receiving, by the pSCP node, a discovery response from the pNRF node, the discovery response comprising NF profiles of one or more NF instances that are topology hidden by the external NF instance;
   selecting, by the pSCP node, a selected NF instance from the one or more NF instances in the discovery response;
   transmitting, by the pSCP node, a service request to the selected NF instance of the one or more NF instances;
   receiving, by the pSCP node, a service request response from the selected NF instance, wherein the selected NF instance that responds is a responding NF instance;
   performing, by the pSCP node, topology hiding of the responding NF instance in response to receiving the service request response; and
   transmitting, by the pSCP node, a response to the pSEPP node, wherein the response comprises an external NF instance identity of the responding NF instance.
25. The method of embodiment 24, wherein the external NF instance identity is in a Hypertext Transfer Protocol (HTTP) header Location and the external NF instance identity hides a Uniform Resource Identifier (URI) of a resource providing the particular service.
26. The method of embodiment 24, further comprising transmitting, by the pSCP node, another service request to a selected alternative NF instance of the one or more NF instances in response to an error or no response from a previously selected NF instance.
27. The method of any of embodiments 24-26, further comprising storing, by the pSCP node, a mapping of the responding NF instance with a provided or created Resource identification (ResourceId) to the external NF instance identity of the responding NF instance.
28. The method of any of embodiments 24-26, further comprising:
   receiving, by the pSCP node, the subsequent request for the particular service from the pSEPP node, wherein the subsequent request comprises the external NF instance;
   determining, by the pSCP node, if a mapping of the responding NF instance exists with a provided or created Resource identification (ResourceId) to the external NF instance identity of the responding NF instance;
   transmitting, by the pSCP node, a subsequent service request to the responding NF instance in response to the mapping existing, wherein the pSCP treats the subsequent service request as a first service request in response to the mapping not existing;
   receiving, by the pSCP node, a subsequent service response from the responding NF instance; and
   transmitting, by the pSCP node, the response to the pSEPP node.
29. The method of embodiment 28, further comprising transmitting, by the pSCP node, the subsequent service request to a selected alternative NF instance of the one or more NF instances in response to an error or not receiving the subsequent service response.
30. The method of embodiment 29, further comprising updating, by the pSCP node, the mapping in response to receiving the subsequent service response from the selected alternative NF instance.
31. A network node configured to perform topology hiding, the network node comprising:
   processing circuitry configured to perform any of the steps of any of embodiments 1-13; and
   power supply circuitry configured to supply power to the processing circuitry.
32. The network node of embodiment 30, wherein the network node comprises a NF Repository Function (NRF) node.
33. A network node for performing topology hiding, the network node comprising:
   processing circuitry configured to perform any of the steps of any of embodiments 14-21; and
   power supply circuitry configured to supply power to the processing circuitry.
34. The network node of embodiment 33, wherein the network node comprises a Security Edge Protection Proxy (SEPP) node.
35. A network node configured to perform topology hiding, the network node comprising:
   processing circuitry configured to perform any of the steps of any of embodiments 22-23; and
   power supply circuitry configured to supply power to the processing circuitry.
36. The network node of embodiment 35, wherein the network node comprises a Security Edge Protection Proxy (SEPP) node.
37. A network node configured to perform topology hiding, the network node comprising:
   processing circuitry configured to perform any of the steps of any of embodiments 24-30; and
   power supply circuitry configured to supply power to the processing circuitry.
38. The network node of embodiment 37, wherein the network node comprises a Service Communication Proxy (SCP) node.

Explanations are provided below for various abbreviations/acronyms used in the present disclosure.

| Abbreviation | Explanation |
|---|---|
| 5GC | 5th Generation Core Network |
| CN | Core Network |
| CNA | Cloud Native Architecture |
| NF | Network Function |
| PLMN | Public Land Mobile Network |
| SBA | Service based Architecture |
| SCP | Service Communication Proxy |
| SEPP | Security Edge Protection Proxy |

1. A method implemented by a network node in a communication infrastructure, that includes a plurality of Public Land Mobile Networks (PLMNs), the method comprising:
receiving, by a Network Function Repository Function (pNRF) node of a producer PLMN (pPLMN), a network function (NF) discovery request for a particular service from a network node of a consumer PLMN (cPLMN);
determining, by the pNRF node, if topology hiding is required for a NF instance that provides the particular service; and
transmitting, by the pNRF node, a discovery response comprising one or more external NF instances, wherein each external NF instance comprises one or more internal NF instances in a Set of NF instances of the pPLMN that require topology hiding from the cPLMN.

2. The method of claim 1, wherein determining if topology hiding is required comprises:
determining if a registration of the NF instance with the pNRF node comprises information for performing topology hiding; or
determining if the registration of the NF instance comprises a flag indicating to perform topology hiding.

3. The method of claim 1, further comprising receiving a request from one or more NF instances for registration.

4. The method of claim 3, further comprising registering each NF instance that needs topology hiding by including external NF instance information in the registration.

5. The method of claim 4, wherein registering each NF instance that needs topology hiding comprises merging registered attributes in an NF profile of each NF instance into a compound external profile for the external NF instance.

6. The method of claim 5, wherein merging the attributes comprises performing a particular action with respect to each attribute based on the attribute.

7. The method of claim 6, wherein the particular action comprises one of:
including the registered attribute in the compound external profile if the registered attribute would be valid in the compound external profile;
replacing the registered attribute in the compound external profile if the registered attribute requires topology hiding;
omitting the registered attribute from the compound external profile if the registered attribute would be invalid in the compound external profile; or
modifying the registered attribute in the compound external profile.

8. The method of claim 4, wherein registering each NF instance that needs topology hiding comprises:
replacing an NF instance identification by an external instance identification; and
replacing a Fully Qualified Domain Name (FQDN) by an external FQDN.

9. The method of claim 8, wherein registering each NF instance that needs topology hiding further includes:
replacing an NF instance name by an external instance name; and/or
associating a flag with the NF instance to indicate that the NF instance should be hidden from access from another PLMN.

10. The method of claim 1, further comprising performing local configuration in the pNRF node to provide topology hiding of at least some NF instances in the Set of NF instances using the external NF instance.

11. The method of claim 10, wherein performing local configuration in the pNRF node comprises:
replacing an NF instance identification by an external instance identification; and
replacing a Fully Qualified Domain Name (FQDN) by an external FQDN.

12. The method of claim 11, wherein performing local configuration in the pNRF node further comprises:
replacing an NF instance name by an external instance name; and/or
associating a flag with the NF instance to indicate that the NF instance should be hidden from access from another PLMN.

13. The method of claim 1, further comprising:
receiving, by the pNRF node, a discovery request from a Security Edge Protection Proxy (pSEPP) node of the pPLMN, wherein the discover request comprises the external NF instance;
determining, by the pNRF node, NF instances that are topology hidden by the external NF instance; and
transmitting, by the pNRF node, a discovery response to the pSEPP node, wherein the discovery response comprises NF profiles of NF instances with external NF instance identifications.

14. A method implemented by a network node in a communication infrastructure, that includes a plurality of public land mobile networks (PLMNs)), the method comprising:
receiving, by a Security Edge Protection Proxy (pSEPP) node of a producer PLMN (pPLMN), a request or a subsequent request for a particular service from a network node of a consumer PLMN (cPLMN), wherein the request or the subsequent request comprises an external network function (NF) instance;
determining, by the pSEPP node, that the external NF instance comprises information corresponding to the pSEPP node and that a destination is hidden in the request;
transmitting, by the pSEPP node, a request to a NF Repository Function (pNFR) node of the pPLMN for getting NF instances in the pPLMN that are topology hidden by the external NF instance;
receiving, by the pSEPP node, a discovery response from the pNFR node, the discovery response comprising NF profiles of one or more NF instances that are topology hidden by the external NF instance;
selecting, by the pSEPP node, a selected NF instance from the one or more NF instances in the discovery response;
transmitting, by the pSEPP node, a service request or a subsequent service request to the selected NF instance of the one or more NF instances;
receiving, by the pSEPP node, a service request response from the selected NF instance, wherein the selected NF instance that responds is a responding NF instance;
performing, by the pSEPP node, topology hiding of the responding NF instance in response to receiving the service request response; and
transmitting, by the pSEPP node, a response to the network node of the cPLMN, wherein the response comprises an external NF instance identity of the responding NF instance.

15. The method of claim 14, wherein transmitting the request to the pNRF for getting the NF instances in the pPLMN that are topology hidden by the external NF instance comprises transmitting a discovery request that uses the external NF instance as a key to get the NF instances that are topology hidden.

16. The method of claim 14, wherein the external NF instance identity is in a Hypertext Transfer Protocol (HTTP) header Location and the external NF instance identity hides a Uniform Resource Identifier (URI) of a resource providing the particular service.

17. The method of claim 14, further comprising transmitting, by the pSEPP node, another service request to a selected alternative NF instance of the one or more NF instances in response to an error or no response from a previously selected NF instance.

18. The method of claim 14, further comprising storing, by the pSEPP node, a mapping of the responding NF instance with a provided or created Resource identification (ResourceId) to the external NF instance identity of the responding NF instance.

19. The method of claim 14, further comprising:
receiving, by the pSEPP node, the subsequent request for the particular service, wherein the subsequent request comprises the external NF instance;
determining, by the pSEPP node, if a mapping of the responding NF instance exists with a provided or created Resource identification (ResourceId) to the external NF instance identity of the responding NF instance;
transmitting, by the pSEPP node, the subsequent service request to the responding NF instance in response to the mapping existing, wherein the pSEPP treats the subsequent service request as a first service request in response to the mapping not existing;
receiving, by the pSEPP node, a subsequent service response from the responding NF instance; and
transmitting, by the pSEPP node, the response to the network node of the cPLMN.

20-22. (canceled)

23. A method implemented by a network node in a communication infrastructure, that includes a plurality of public land mobile networks (PLMNs), the method comprising:
receiving, by a Security Edge Protection Proxy (pSEPP) node of a producer PLMN (pPLMN), a request for a particular service from a network node of a consumer PLMN (cPLMN), wherein the request comprises an external network function, NF, instance;
performing one of:
determining, by the pSEPP node, that the external NF instance comprises information corresponding to the pSEPP node and that the destination is hidden in the request, wherein the method further comprises:
determining, by the pSEPP node, that indirect communication is required; and
transmitting the request for the particular service to a Service Communication Proxy (pSCP) node of the pPLMN, wherein the transmitted request comprises a flag indicating there is topology hiding; or
determining, by the pSEPP node, that the external NF instance identifies the pSCP node or any virtual target of the pPLMN and identifies that indirect communication is required, wherein the method further comprises transmitting the request for the particular service to the pSCP.

24-47. (canceled)
